(19) United States
(12) Patent Application Publication
(10) Pub. No.: US 2026/0180603 A1
(43) Pub. Date: Jun. 25, 2026

(54) RADIO FREQUENCY RECEIVER ARCHITECTURE

(71) Applicant: QUALCOMM Incorporated, San Diego, CA (US)

(72) Inventors: Ojas CHOKSI, San Diego, CA (US); Chirag Dipak PATEL, San Diego, CA (US)

(21) Appl. No.: 18/999,809

(22) Filed: Dec. 23, 2024

(51) Int. Cl. H04B 1/00; H04B 1/16

(52) U.S. Cl. CPC H04B 1/0075; H04B 1/16

(57) ABSTRACT

A method of converting RF signals to IF signals includes: receiving, at first and second receiver subcircuits of an apparatus, first and second RF signals of first and second different RF frequency bands; converting, using a first mixer of the first receiver subcircuit of the apparatus, at least a first subset of the first RF signals to a first IF signal during a first mode of the apparatus; and during a second mode of the apparatus that is a MIMO (Multiple Input Multiple Output) mode, one of (1) converting, using the first mixer, a second subset of the first RF signals to a second IF signal and providing a third subset of the first RF signals to the second receiver subcircuit, and (2) converting, using the first mixer, at least a fourth subset of the second RF signals to a third IF signal.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi®, BLUETOOTH® and other short-range wireless communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, available volume for antennas is at a premium. For example, smartphones may have numerous antennas (e.g., eight antennas, 10 antennas, or more) with very limited volume due to the size of devices that consumers desire. Consequently, antenna assemblies (e.g., modules) may be limited to very small volumes, e.g., with widths of 4 mm or less.

Despite the volume restrictions for antennas, desired functionality of the antennas continues to increase. With the advent of 5th generation (5G) of wireless communication technology, mmW (millimeter-wave) phased-array antennas have received extensive attention to address the propagation loss and aperture blockage hurdles by introducing higher antenna gain and beamforming features. Multiple-input-multiple-output (MIMO) systems is one of the key enablers of 5G technology to increase the spectral efficiency and system capacity by effectively streaming the transmit/receive data with two orthogonally polarized signals (cross-polarized signals) in desired directions. The trend in consumer electronics is to develop RF (Radio Frequency) assemblies (radio frequency assemblies) with small form factors which can be easily accommodated within the limited space of the emerging smart devices including cell phones and tablets. The physical requirements of antennas make maintaining or improving performance (e.g., in terms of coverage, latency, and quality of service over desired coverage area) difficult.

Production of wireless communication devices, including millimeter-wave integrated circuit (IC) production, is costly in terms of test procedures, equipment, and testing time, and may be impractical to perform after manufacture, e.g., during mission operation. On-chip built-in self-test (BIST) circuitry may reduce cost, including testing time, but presents challenges to enable accurate test results.

### SUMMARY

An example method of converting radio frequency (RF) signals to intermediate frequency (IF) signals includes: receiving, at a first receiver subcircuit of an apparatus, first RF signals of a first RF frequency band; receiving, at a second receiver subcircuit of the apparatus, second RF signals of a second RF frequency band that is different from the first RF frequency band; converting, using a first mixer of the first receiver subcircuit of the apparatus, at least a first subset of the first RF signals to a first IF signal during a first mode of the apparatus; and during a second mode of the apparatus that is a MIMO (Multiple Input Multiple Output) mode, one of (1) converting, using the first mixer, a second subset of the first RF signals to a second IF signal and providing a third subset of the first RF signals to the second receiver subcircuit, and (2) converting, using the first mixer, at least a fourth subset of the second RF signals to a third IF signal.

An example RF signal processing circuit includes: an IF port; and a first receiver subcircuit communicatively coupled to the IF port and configured to receive first RF signals, of a first RF frequency band, from first antenna elements, the first receiver subcircuit including a first mixer; a second receiver subcircuit communicatively coupled to the IF port and configured to receive second RF signals, of a second RF frequency band that is different from the first RF frequency band, from second antenna elements; a controller, communicatively coupled to the first receiver subcircuit, configured to: cause, during a first mode of the RF signal processing circuit, the first mixer to convert at least a first subset of the first RF signals to a first IF signal; and cause, during a second mode of the RF signal processing circuit that is a MIMO mode, one of (1) the first mixer to convert a second subset of the first RF signals to a second IF signal and the first receiver subcircuit to provide a third subset of the first RF signals to the second receiver subcircuit, and (2) the first mixer to convert at least a fourth subset of the second RF signals to a third IF signal.

An example RF signal processing circuit for converting RF signals to IF signals includes: means for receiving first RF signals of a first RF frequency band; means for receiving second RF signals of a second RF frequency band that is different from the first RF frequency band; first-mode means for converting, using a first mixer, at least a first subset of the first RF signals to a first IF signal during a first mode of the RF signal processing circuit; and second-mode means, during a second mode of the RF signal processing circuit that is a MIMO mode, one of (1) converting, using the first mixer, a second subset of the first RF signals to a second IF signal and providing a third subset of the first RF signals to the means for receiving the second RF signals, and (2) converting, using the first mixer, at least a fourth subset of the second RF signals to a third IF signal.

An example non-transitory, processor-readable storage medium includes processor-readable instructions to cause at least one processor of an RF signal processing circuit, that includes: an IF port; a first receiver subcircuit communicatively coupled to the IF port and configured to receive first RF signals, of a first RF frequency band, from first antenna elements, the first receiver subcircuit including a first mixer; and a second receiver subcircuit communicatively coupled to the IF port and configured to receive second RF signals, of a second RF frequency band that is different from the first RF frequency band, from second antenna elements, to: cause, during a first mode of the RF signal processing circuit, the first mixer to convert at least a first subset of the first RF signals to a first IF signal; and cause, during a second mode of the RF signal processing circuit that is a MIMO mode, one of (1) the first mixer to convert a second subset of the first RF signals to a second IF signal and the first receiver subcircuit to provide a third subset of the first RF signals to the second receiver subcircuit, and (2) the first mixer to convert at least a fourth subset of the second RF signals to a third IF signal.

### BRIEF DESCRIPTION OF THE DRAWINGS

FIG. 1 is a schematic diagram of a communication system.

FIG. 2 is a block diagram of a user equipment including a transceiver.

FIG. 3 is a circuit diagram of a receiver circuit.

FIG. 4 is an example of the receiver circuit shown in FIG. 3 indicating actuated components in a single-band or interband CA (carrier aggregation) mode.

FIG. 5 is an example of the receiver circuit shown in FIG. 3 indicating actuated components in a low-band 4×4 MIMO (Multiple Input Multiple Output) mode.

FIG. 6 is an example of the receiver circuit shown in FIG. 3 indicating actuated components in a high-band 4×4 MIMO mode.

FIG. 7 is a more detailed circuit diagram of the receiver circuit shown in FIG. 3.

FIG. 8 is a block diagram of a user equipment in accordance with the disclosure, including an RF (Radio Frequency) signal processing circuit.

FIG. 9A is a circuit diagram in accordance with the disclosure of an example of a portion of the RF signal processing circuit shown in FIG. 8.

FIG. 9B is the circuit diagram shown in FIG. 9A indicating actuated components of a high-band, single-band mode.

FIG. 9C is the circuit diagram shown in FIG. 9A indicating actuated components of a low-band, single-band mode.

FIG. 9D is the circuit diagram shown in FIG. 9A indicating actuated components of a high-band, four-layer MIMO mode.

FIG. 9E is the circuit diagram shown in FIG. 9A indicating actuated components of a low-band, four-layer MIMO mode.

FIG. 9F is the circuit diagram shown in FIG. 9A indicating actuated components of a low-plus-high-band interband CA mode.

FIG. 10 is a circuit diagram of a portion of the circuit shown in FIG. 9A.

FIG. 11 is a circuit diagram of a selection circuit of the circuit shown in FIG. 9A.

FIG. 12 is a block diagram comparing intermediate frequency ranges of intermediate frequency signals used in the circuit shown in FIG. 3 versus the circuit shown in FIG. 9A for various operational modes of the circuits.

FIG. 13 is a block flow diagram of a method of converting radio frequency signals to intermediate frequency signals.

### DETAILED DESCRIPTION

Techniques are discussed herein for converting RF (Radio Frequency) signals to IF (Intermediate Frequency) signals. For example, an RF signal processing circuit may receive RF signals and process the received signals through variable gain amplifiers before being input to a shared IQ hybrid circuit between multiple antenna elements (In-phase/Quadrature-phase hybrid circuit which splits the incoming signal into in-phase and quadrature-phase signals). Voltage signals output by one or more IQ hybrid circuits may be multiplexed and converted to one or more current signals via transconductance (Gm) circuits (and combined into a combined current signal if multiple current signals are available for combining). One or more of such combined signals may be mixed to produce an IF signal. Reference signals may be selectively provided for mixing with the combined current signal(s) to provide IF signals of selected frequencies. The frequencies of the IF signals for different modes may be controlled. This may facilitate operation of the RF signal processing circuit and/or facilitate mode fast switching (e.g., between Single band 2L (two layer) MIMO (Multiple Input Multiple Output), Single band 4L (4 layer) MIMO, Interband CA, etc.) which may facilitate and/or improve signal reception and signal decoding accuracy. The IF signal frequency may be controlled to be in a low IF frequency range for low-band (LB) or high-band (HB) single-band 2L MIMO operation to save power. A mode may be switched from 2L MIMO to 4L, with the added two layers using a higher side of an IF range of LB/MB, without disrupting the original 2L occupying the lower side of the IF range and while maintaining phase continuity and peak throughput without switching PLL frequencies. IF signals may be routed through a selection circuit that selectively bypasses frequency filtering, or applies appropriate frequency filtering (high pass or low pass) to facilitate frequency multiplexing of signals on the same signal line concurrently while filtering IBB (In-band Blocker) jammers overlapping with the signal. Examples include active combining using a shared LO in a mmW IC. For example, various paths may be muxed to an MHB (Mid-High Band) or LB mixer instead of routing the local oscillator signal(s). This may reduce the number of paths coupled to the IF port, and increase the efficiency of MIMO processing. Other configurations, however, may be used.

Items and/or techniques described herein may provide one or more of the following capabilities, and possibly one or more other capabilities not mentioned. Signal reception modes may be changed between single-band 2L and 4L MIMO while meeting stringent settling-time requirement ( ) e.g., by using the same or similar frequency provided by an intermediate frequency local oscillator (IFLO). Signal reception modes may be changed between single-band 2L and 4L MIMO while, maintaining phase continuity and throughput. Circuitry area (e.g., of a PCB (Printed Circuit Board)) may be conserved for single band 2L and 4L MIMO operation, e.g., by not using dedicated MIMO paths, sharing IQ hybrids between multiple antenna elements, avoiding multiple stages of low noise amplifiers, RF variable gain amplifiers (VGA), IF amplifiers and bulky Wilkinson combiners, and/or by performing 4-to-1 active combining/current combining compared to 2-to-1 power combining. Power consumption may be reduced for single band 2L and 4L MIMO operation, e.g., by routing RF (Radio Frequency) signals of one band, rather than large swing local oscillator signals, to mixer circuitry associated with a different band. Circuitry cost may be reduced for single band 2L and 4L MIMO operation. For example, fewer Wilkinson combiners, fewer amplifiers, and fewer mixers may be used for single band 2L and 4L MIMO operation. Operation may be switched between single band operation 2L and 4L MIMO operation without reconfiguring carrier aggregation filters or changing/reconfiguring RFPLL, IFPLL frequencies. A lower IF range may be used for both LB/MB LGY (legacy) to save power. Under co-existence scenarios (e.g., FR1+FR2, FR3+FR2, etc.), architectures discussed herein may provide flexibility to move the IF frequency range for each LB/MHB (Mid-High Band) signal path to avoid jammers and improve self-desense as well as de-sense to other technologies. Thus, IF ranges may be swapped for an LB/MHB mixer for FR2/FR3/radar applications for co-existence/jamming scenarios. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

The discussion herein focuses on communication systems using phased arrays, and in particular mmW (millimeter-wave) communication systems, e.g., for FR2, FR2-2, FR3, D-band, and radar applications (e.g., FMCW (Frequency Modulated Continuous Wave), MPE (Maximum Permissible Exposure) (i.e., maximum radiation exposure of a person without harmful effect(s)), gesture recognition, etc.). The techniques discussed herein, however, may be used for other applications, for example systems which are configured for operation at higher (e.g., sub-THz) or lower frequencies.

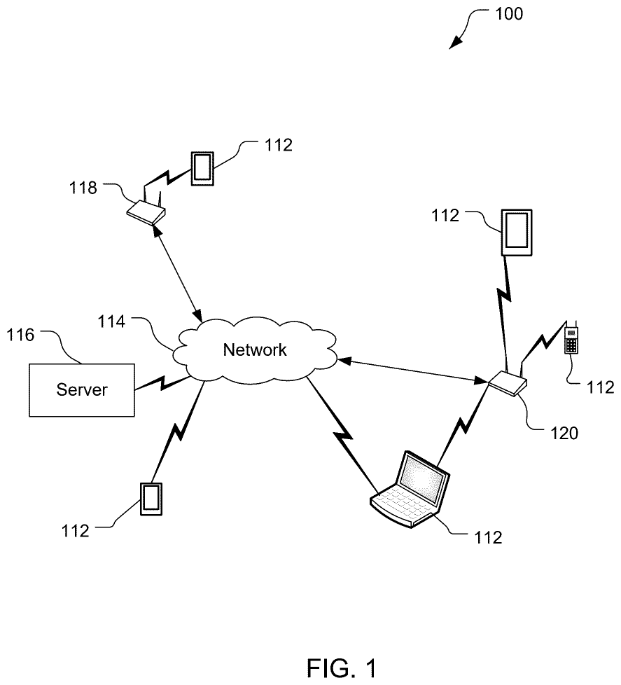

Referring to FIG. 1, a communication system 100 includes mobile devices 112, a network 114, a server 116, and access points (APs) 118, 120. The communication system 100 is a wireless communication system in that components of the communication system 100 can communicate with one another (at least sometimes) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, the network 114, the server 116, and/or the APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi® communication, multiple frequencies of Wi-Fi® communication, satellite communication and/or positioning, one or more types of cellular communications (e.g., GSM (Global System for Mobiles), CDMA (Code Division Multiple Access), LTE (Long-Term Evolution), etc.), 5G-NR (FR1, FR2, FR2-2,), 6G/FR3, Bluetooth® communication, etc.). Each of the mobile devices 112 may be referred to as a user equipment (UE).

As used herein, the term “user equipment” and “UE” are not specific to or otherwise limited to any particular Radio Access Technology (RAT), unless otherwise noted. In general, UEs may be any wireless communication device (e.g., a mobile phone, router, tablet computer, laptop computer, consumer asset tracking device, Internet of Things (IOT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Further, two or more UEs may communicate directly in some configurations with or without passing information to each other through a network.

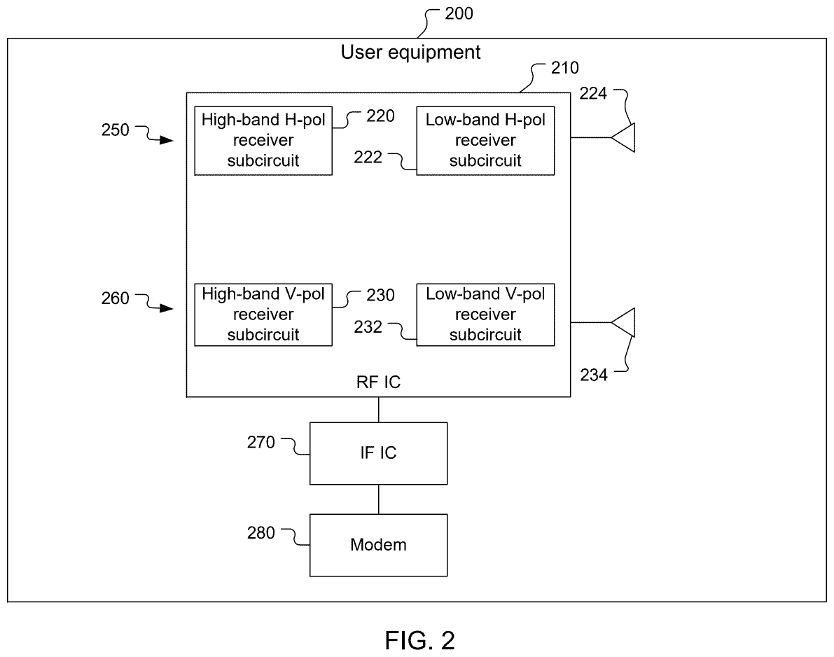

Referring to FIG. 2, a UE 200 (e.g., an example of the mobile devices 112) includes a receiver 210 of an RF IC (Radio Frequency Integrated Circuit), an IF IC 270 (Intermediate Frequency Integrated Circuit), and a modem 280. The receiver 210 comprises more than one receiver subcircuit, here receiver subcircuits 220, 222, 230, 232, with different subcircuits configured to receive respective signals, e.g., of different frequencies and different polarizations. For example, the receiver subcircuit 220 may be configured for receiving high-band horizontal-polarization signals (as received by a horizontally-polarized antenna 224). The UE 200 may have multiple H/V (horizontal/vertical) polarization antennas and may coherently combine a signal using phase shifters for the same layer (horizontal or vertical polarization). The receiver subcircuit 222 may be configured for receiving low-band horizontal-polarization signals (as received by the horizontally-polarized antenna 224). The receiver subcircuit 230 may be configured for receiving high-band vertical-polarization signals (as received by a vertically-polarized antenna 234). The receiver subcircuit 232 may be configured for receiving low-band vertical-polarization signals (as received by the vertically-polarized antenna 234). The UE 200 may also include components for signal transmission, e.g., using the antennas 224, 234, such that the receiver subcircuits 220, 222, 230, 232 may be portions of respective transceiver subcircuits of a transceiver, but these components are not shown in FIG. 2 (or other figures) for sake of simplicity of the figures. The antennas 224, 234 may be communicatively coupled to respective receiver subcircuits and may be implemented as a single antenna with dual polarization. Further, separate antennas may be used for low-band and high-band signals. The low-band signals are in a “low” frequency band that is lower than a “high” frequency band of the high-band signals. The low band and high band may, for example, comprise a low mmW band (e.g., 24 GHz-29.5 GHz) and a mid mmW Band (37-43.5 GHz) and a high mmW band (e.g., 48 GHz), respectively. The subcircuits 220, 222, 230, 232 may be disposed in respective portions (e.g., quadrants) of the receiver 210 as shown, e.g., respective quadrants of an integrated circuit comprising the receiver 210.

The subcircuits 220, 222 may be parts of what is called a horizontal layer or “H-layer” 250 and the subcircuits 230, 232 may be parts of what is called a vertical layer or “V-layer” 260. The H-layer 250 comprises circuitry for processing (e.g., generating, amplifying, measuring, and/or decoding, etc.) signals corresponding to (e.g., to be transmitted with and/or signals received with) a first polarization (here, a horizontal polarization, i.e., an H-pol). The V-layer 260 comprises circuitry for processing (e.g., generating, amplifying, measuring, and/or decoding, etc.) signals corresponding to a second polarization (here, a vertical polarization, i.e., a V-pol) that is different from, e.g., orthogonal to, the first polarization. Types of polarization other than horizontal and vertical—for example, slant polarization, circular polarization, etc.—may be implemented. Further, within a subcircuit, different subsets of components may be used to obtain and process signals separately, e.g., with signals received by two antenna elements processed differently than signals received by two other antenna elements, and the different signals, or sets of components, may be referred to as different layers. Thus, for example, a four-layer high-band MIMO (Multiple Input Multiple Output) implementation may separately process signals from two antenna elements of the subcircuit 220, signals from two other antenna elements of the subcircuit 220, signals from two antenna elements of the subcircuit 230, and signals from two other antenna elements of the subcircuit 230.

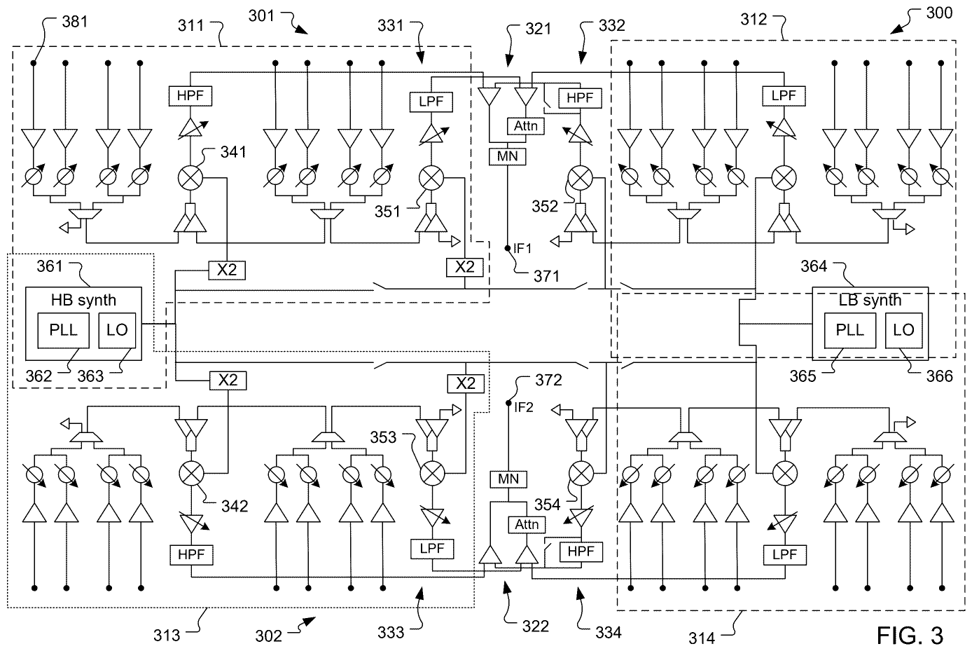

Referring to FIG. 3, a receiver 300 includes a high-band (HB) H-pol receiver subcircuit 311, a low-band (LB) H-pol receiver subcircuit 312, an HB V-pol receiver subcircuit 313, an LB V-pol receiver subcircuit 314, an H-pol IF coupling circuit 321, a V-pol coupling circuit 322, an HB H-pol MIMO circuit 331, an LB H-pol MIMO circuit 332, an HB V-pol MIMO circuit 333, and an LB V-pol MIMO circuit 334. The subcircuits 311, 312 are in an H-pol layer 301 of the receiver 300 and the subcircuits 313, 314 are in a V-pol layer 302 of the receiver 300. The H-pol layer 301 includes the subcircuits 311, 312, the H-pol IF coupling circuit 321, and the LB H-pol MIMO circuit 332. The V-pol layer 302 includes the subcircuits 313, 314, the V-pol IF coupling circuit 322, and the LB V-pol MIMO circuit 333. In circuit figures, i.e., FIGS. 3-7, FIGS. 9A-9F, FIG. 10, and FIG. 11, lines that cross each other are not connected (shorted) to each other. The receiver 300 may include other elements not shown. For example, many components (e.g., amplifiers and switches) are not shown in order to reduce the complexity of FIG. 3. For example, selective connections of the subcircuits 311, 312 to the H-pol IF circuit 321 and selective connections of the subcircuits 313, 314 to the V-pol IF circuit 322 are omitted from FIG. 3. In the receiver 300, each of the subcircuits 311-314 includes a single (or common, when there are more than one) mission mixer (with only mission mixers 341, 342 labeled in FIG. 3) used for mission signal reception (e.g., communication signal reception, data signal reception, positioning signal reception, etc.). Further, each of the MIMO circuits 331-334 includes a respective MIMO mixer 351, 352, 353, 354. Thus, there are dedicated mixers in the receiver 300 for MIMO operation. The subcircuits 311, 313 share an HB synthesizer 361, that contains an HB PLL 362 (Phase-Locked Loop), and an HB LO 363 (Local Oscillator), and the subcircuits 312, 314 share an LB synthesizer 364, that contains an HB PLL 365, and an LB LO 366. Each of the subcircuits 311, 313 is considered to include the HB synthesizer 361 and each of the subcircuits 312, 314 is considered to include the LB synthesizer 364. That is, the HB synthesizer 361 is part of (and coupled to circuitry of) both of the H-pol and V-pol layers of the receiver 300) and the LB synthesizer 364 is part of (and coupled to circuitry of) both of the H-pol and V-pol layers of the receiver 300.

Each layer of the receiver 300 includes an IF port (an intermediate frequency port), here IF ports 371, 372. The IF ports 371, 372 may be called IF I/O ports (IF input/output ports). The IF ports 371, 372 are configured to be coupled to an IF IC (an IF integrated circuit) that is configured to receive IF signals via the IF ports 371, 372 and convert the IF signals to baseband signals for further processing, e.g., aggregation, integration, decoding, etc. The IF ports 371, 372 may be disposed at opposite sides of the receiver 300, e.g., corresponding to opposite edges of an IC containing the receiver 300. Each of the IF ports 371, 372 is coupled to respective ones of the subcircuits 311-314 by a respective matching network (MN) that may provide some selectivity to filter jammers. The subcircuits 311-314 include RF ports (only an RF port 381 of the subcircuit 311 is labeled in FIG. 3) that may each be coupled to a respective antenna element for reception of guided signals from the antenna elements (that the antenna element transduced from wireless signals to guided signals). The RF ports may thus receive RF signals that the subcircuits 311-314 convert to IF signals that are provided to the IF ports 371, 372. The RF ports may be disposed for coupling to the antenna elements. The antenna elements may be disposed, for example, on an integrated circuit chip that is separate from an IC chip containing the receiver 300. The IC chip containing the receiver 300 may be overlaid with the IC chip containing the antenna elements.

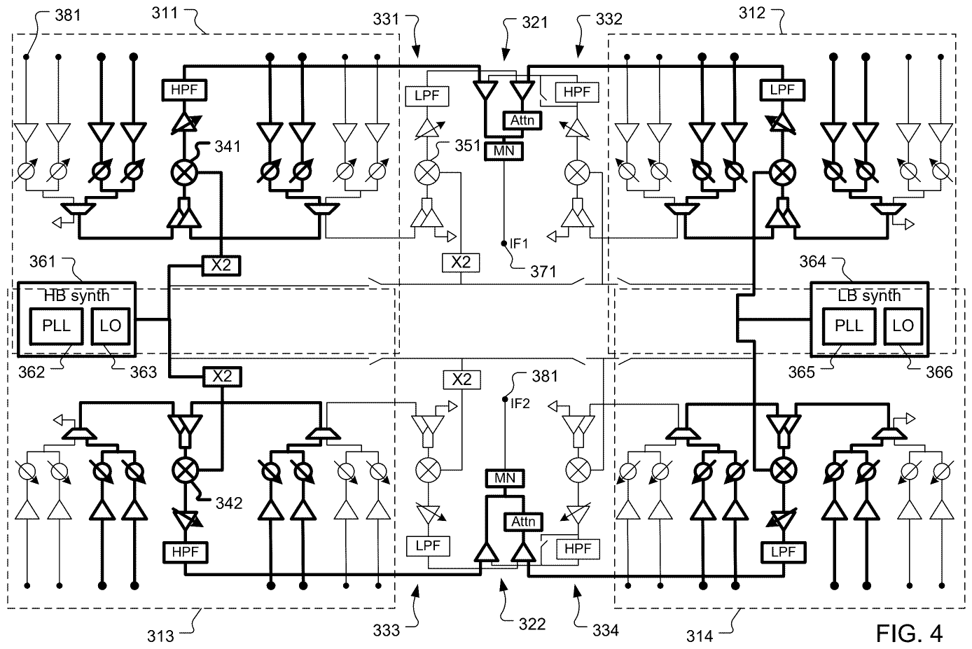

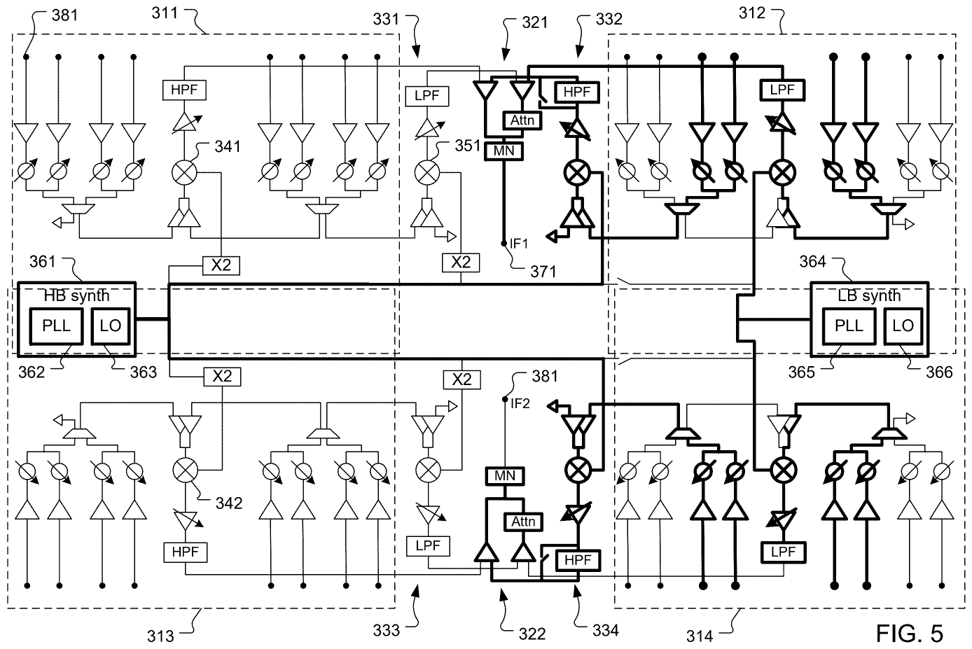

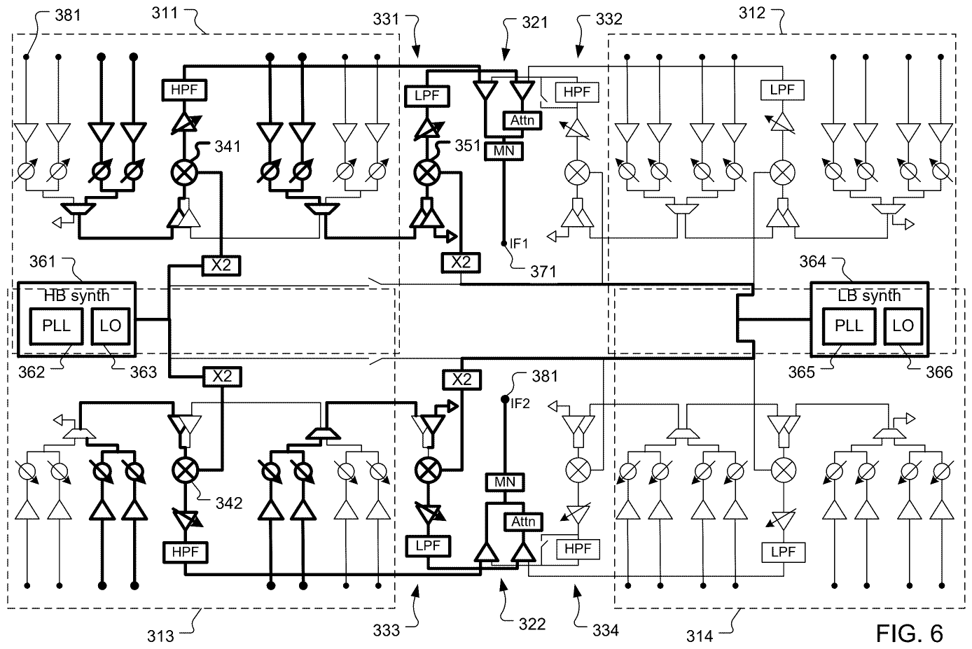

Referring also to FIG. 4, FIG. 5, and FIG. 6, the receiver 300 may be used for various modes of operation. In FIGS. 4-6, non-bold components indicate components that are not used (e.g., turned off or inhibited from receiving a signal (e.g., with one or more switches (whether shown in FIGS. 4-6 or not) being open)), and bolded components indicate components in use (e.g., components turned on and receiving/passing a signal). A bolded switch is in use (closed), even if shown in the open position. For LB 2L, HB 2L, L+M 2L (low-plus-mid) band, or L+H 2L (low-plus-high band) interband carrier aggregation (CA) operation as shown in FIG. 4, a portion of the receiver 300 is operated, with the operational portion shown in bold lines in FIG. 4. A subset of paths (of respective amplifiers and phase shifters) of each of the subcircuits 311-314 may be operated to route a respective subset of RF signals from a respective subset of the RF ports through the H-pol IF coupling circuit 321 or the V-pol IF coupling circuit 322. RF signals are contained within the respective subcircuit 311-314 that receives the RF signals, and are routed to the mission mixer for that subcircuit. For low-band 4×4 MIMO operation (4 layers) as shown in FIG. 5, a subset of paths within each of the subcircuits 312, 314 may be operated to route a first subset of RF signals from a respective subset of the RF ports through the respective mission mixer to the H-pol IF coupling circuit 321 and the V-pol IF coupling circuit 322, respectively. A different subset of paths within each of the subcircuits 312, 314 may be operated to route a second subset of RF signals from a respective subset of the RF ports through to the respective MIMO circuit 332, 334 (and thus the respective MIMO mixer), and then to the H-pol IF coupling circuit 321 and the V-pol IF coupling circuit 322, respectively. For high-band 4×4 MIMO operation as shown in FIG. 6, a subset of paths within each of the subcircuits 311, 313 may be operated to route a first subset of RF signals from a respective subset of the RF ports through the respective mission mixer to the H-pol IF coupling circuit 321 and the V-pol IF coupling circuit 322, respectively. A different subset of paths within each of the subcircuits 311, 313 may be operated to route a second subset of RF signals from a respective subset of the RF ports through to the respective MIMO circuit 331, 333 (and thus the respective MIMO mixer), and then to the H-pol IF coupling circuit 321 and the V-pol IF coupling circuit 322, respectively.

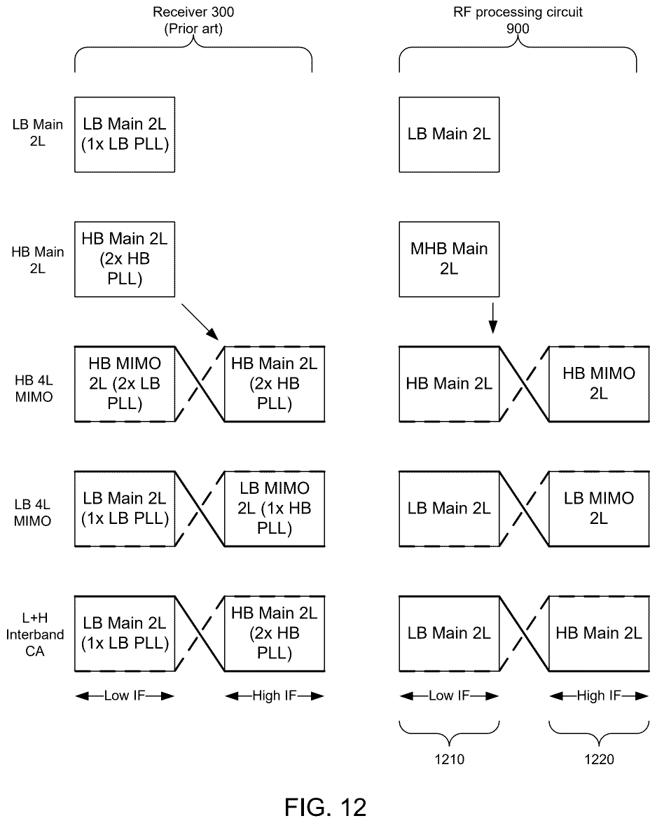

There are various aspects of the different operation modes shown in FIGS. 4-6. The LB 4×4 MIMO and HB 4×4 MIMO operation uses similar spectral combining as the L+M or L+H interband operation. As shown in FIG. 12, the signals output by the mission mixer for LB or for HB operation are in a low-IF range in order to save power (using a non-multiplied (1×) oscillator signal from the LB PLL 362). Further, the signals output by the mission mixer (of subcircuits 312, 314) for LB 4L MIMO operation is in the low-IF range and the signals output by the MIMO mixer (of subcircuits 312, 314) are in a high-IF range (e.g.,). For HB 4L MIMO operation, the signals output by the mission mixer (of subcircuits 311, 313) are in the low-IF range and the signals output by the MIMO mixer (of subcircuits 311, 313) are in the high-IF range. For L+H interband operation, the signals output by the mission mode mixer of the subcircuits 312, 314 is in the low-IF band and the signals output by the mission mode mixer of the subcircuits 311, 313 are in the high-IF band. Using IF signals in the low-band IF rather than the high-band IF helps save power. When we switch from 2L to 4L MIMO, the added 2L always occupy higher IF range while the original 2L occupy lower IF range, thus avoiding frequency changes in the RFPLL/IFPLL and phase discontinuity for the initial two layers. For modes where multiple signals are multiplexed onto the same transmission line, the different signals may be filtered differently before being multiplexed. One IF signal may be passed through a low-pass filter (LPF) to pass signals that are below a first threshold frequency of the low IF range and reject any signals/jammers above the second threshold frequency Another IF signal may be passed through a high-pass filter (HPF) to pass signals above a third threshold frequency and reject signals/jammers below a fourth threshold frequency. The filtered signals may then be multiplexed on the same transmission line concurrently. Frequency multiplexing different signals on the same transmission line allows the reduction of IF ports. In the examples of FIGS. 4-6, example subsets of RF signal paths are operated, but these are examples only and RF signal paths, including other quantities of signal paths, may be operated. For example, for single band 2L operation (e.g., HB or LB), all RF signal paths in the desired band of operation (e.g., all RF paths in any of the subcircuits 311-314, or all RF paths in the subcircuits 311, 313 for HB operation, or all RF paths in the subcircuits 312, 314 for LB operation) may be used. Also, for 4L MIMO operation shown in FIG. 5, a local oscillator signal from the HB synthesizer 361 is sent to the LB subcircuits 312, 314, and for 4L MIMO operation shown in FIG. 6, a local oscillator signal from the LB synthesizer 364 is sent to the HB subcircuits 311, 313. This may consume significant power due to the synthesizers 361, 364 being significantly displaced from the subcircuits 312, 314 and the subcircuits 311, 313, respectively and the requirement of sufficient local oscillator signal amplitude for downconversion. Sets of signals are filtered before being multiplexed to the same line such that the signals can be frequency multiplexed on the same transmission line concurrently.

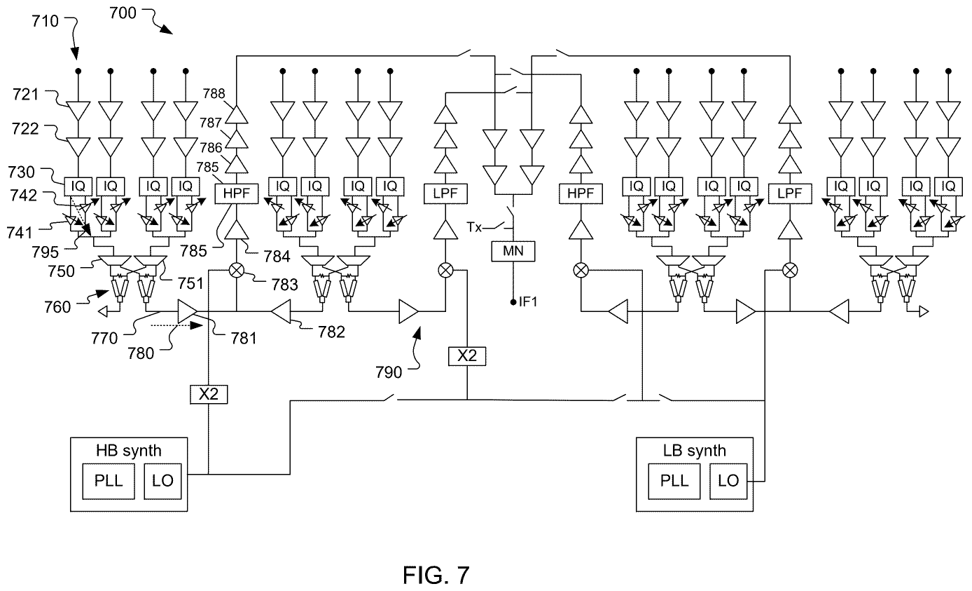

Referring also to FIG. 7, a receiver 700 may be equivalent to the receiver 300, with more details shown in the receiver 700. As shown, in each RF path, e.g., an RF path 710, there are multiple low noise amplifiers 721, 722, an IQ hybrid circuit 730 (In-phase/Quadrature-phase hybrid circuit), and a pair of variable gain amplifiers 741, 742, one for an in-phase signal and one for a quadrature-phase signal output by the IQ hybrid circuit 730, to implement a vector modulator/phase shifter. Outputs of the variable amplifiers 741, 742 are combined, then combined with a similar signal output from another pair of variable gain amplifiers), and the combined signal provided to a multiplexer 750. Outputs of the multiplexer 750 along with outputs from a paired multiplexer 751 are provided to a Wilkinson combiner 760 that combines power of the two signals and provides a combined signal 770 to mission mode path 780, in particular an RF amplifier 781 of the mission mode path. The mission mode path 780 includes the RF amplifier 781, another RF amplifier 782, a mission mode mixer 783, and a pre-filter buffer 784 (IF amplifier), a frequency filter 785 (here a high-pass filter (HPF)), and post-filter buffers/IF amplifiers 786, 787, 788. A MIMO path 790 includes multiple amplifiers, a MIMO mixer, and a frequency filter (here, an LPF). Various components of the receiver 700 may be eliminated, and a position within RF paths of remaining IQ hybrid circuits moved. The 2^{nd} stage of the low noise amplifier 722, one IQ hybrid circuit in each pair of RF paths, the Wilkinson combiners, the buffers 787, 788, and the MIMO path 790 may be eliminated for receivers in accordance with the disclosure. Further, the remaining IQ hybrid circuit, e.g., the IQ hybrid circuit 730, may be positioned after the variable amplifiers 741, 742 (and the associated pair of variable amplifiers from an adjoining RF path), as indicated by an arrow 795.

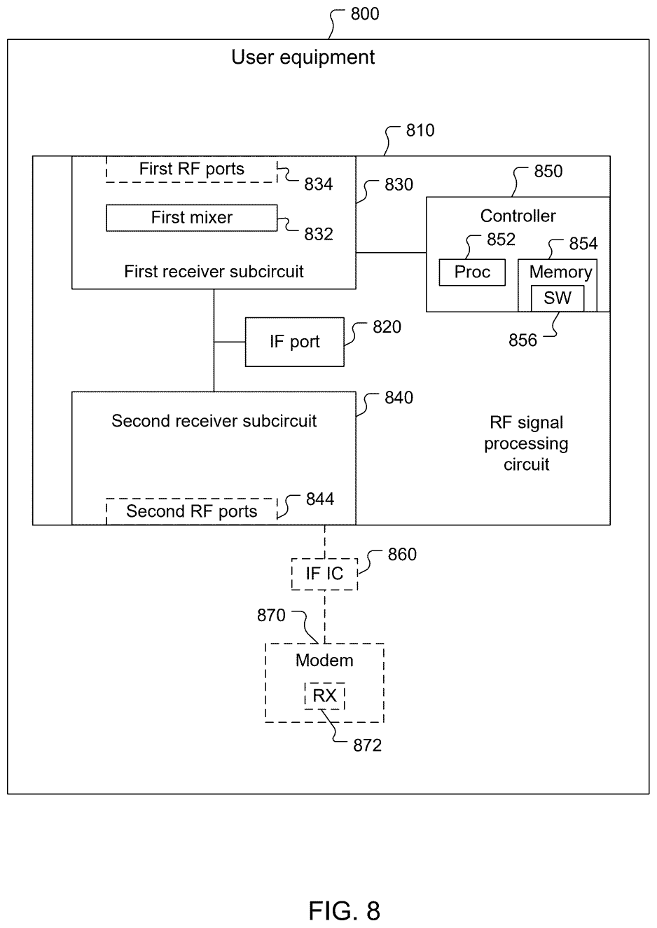

Referring also to FIG. 8, a UE 800 includes an RF signal processing circuit 810 that includes an IF port 820, a first receiver subcircuit 830, a second receiver subcircuit 840, and a controller 850. The first receiver subcircuit 830 and the second receiver subcircuit 840 are communicatively coupled to the IF port 820, and the controller 850 is communicatively coupled to the first receiver subcircuit 830. The first receiver subcircuit 830 includes a first mixer 832 and is configured to receive first RF signals (e.g., via first RF ports 834 that are configured to be coupled to first antenna elements, e.g., on an antenna chip). The second receiver subcircuit 840 is configured to receive second RF signals (e.g., via second RF ports 844 that are configured to be coupled to second antenna elements, e.g., on the antenna chip). The controller 850 is configured to control operation of the first receiver subcircuit 830 and the second receiver subcircuit 840. The subcircuits 830, 840 may be, for example, a low-band and a high-band receiver subcircuit of an H-layer or of a V-layer. Other configurations may be used, e.g., including third and fourth receiver subcircuits of a different polarization layer than the first and second receiver subcircuits 830, 840.

The UE 800 may include an IF IC 860 (IF Integrated Circuit) and a modem 870, and the RF signal processing circuit 810 may be communicatively coupled to the IF IC 860, which may be communicatively coupled to the modem 870 (which may be implemented on another IC). The modem 870 may comprise a receive circuit 872 configured to receive and process (e.g., measure and/or decode) signals received from the RF signal processing circuit 810, e.g., via the I/O port 820. The I/O port 820 may comprise, for example, an electrically-conductive bump configured to be connected to the IF IC 860, or a transmission line connected to the IF IC 860. The controller 850 may be partially or wholly implemented within the modem 870 in some configurations.

The controller 850 may include a processor 852 and a memory 854 that stores software 856. Even if referred to in the singular, the processor 852 may include one or more processors, and the memory 854 may include one or more memories. The processor 852 may include one or more hardware devices, e.g., a central processing unit (CPU), a microcontroller, an application specific integrated circuit (ASIC), etc. The processor 852 may comprise multiple processors including a general-purpose/application processor and/or a Digital Signal Processor (DSP). One or more of these processors may comprise multiple devices (e.g., multiple processors). The memory 854 may be a non-transitory storage medium that may include random access memory (RAM), flash memory, disc memory, and/or read-only memory (ROM), etc. The memory 854 may store the software 856 which may be processor-readable, processor-executable software code containing instructions that may be configured to, when executed, cause the processor 852 (e.g., one or more processors of the controller 850) to perform various functions described herein. Alternatively, the software 856 may not be directly executable by the processor 852 but may be configured to cause the processor 852, e.g., when compiled and executed, to perform the functions. The description herein may refer to the controller 850 or the processor 852 performing a function, but this includes other implementations such as where the processor 852 executes software and/or firmware. The description herein may refer to the controller 850 or the processor 852 performing a function as shorthand for one or more processors of the processor 852 performing the function. The description herein may refer to the UE 800 performing a function as shorthand for one or more appropriate components of the UE 800 performing the function. The processor 852 may include a memory with stored instructions in addition to and/or instead of the memory 854. Functionality of the controller 850 and the processor 852 are discussed more fully herein.

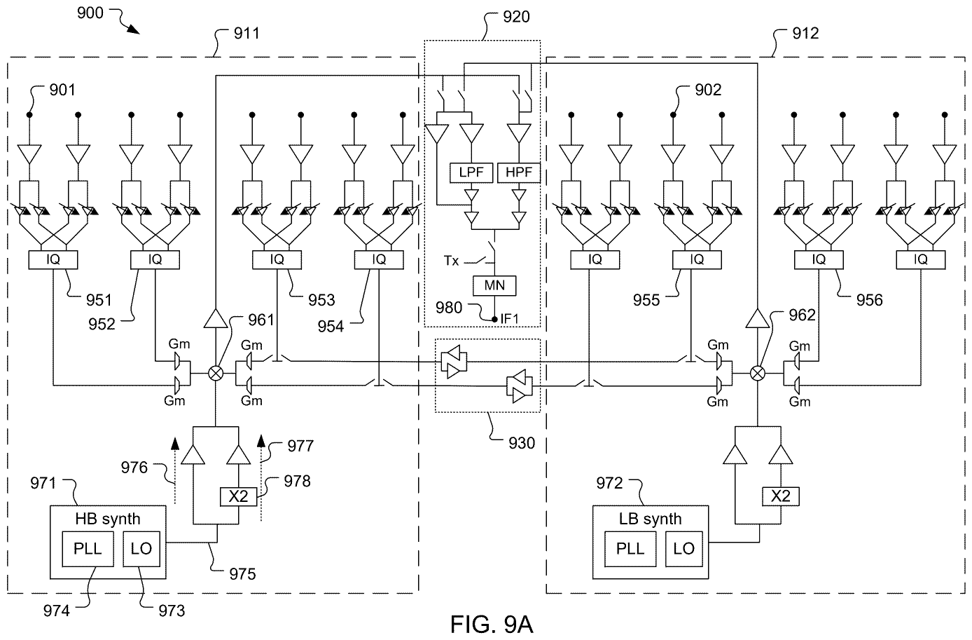

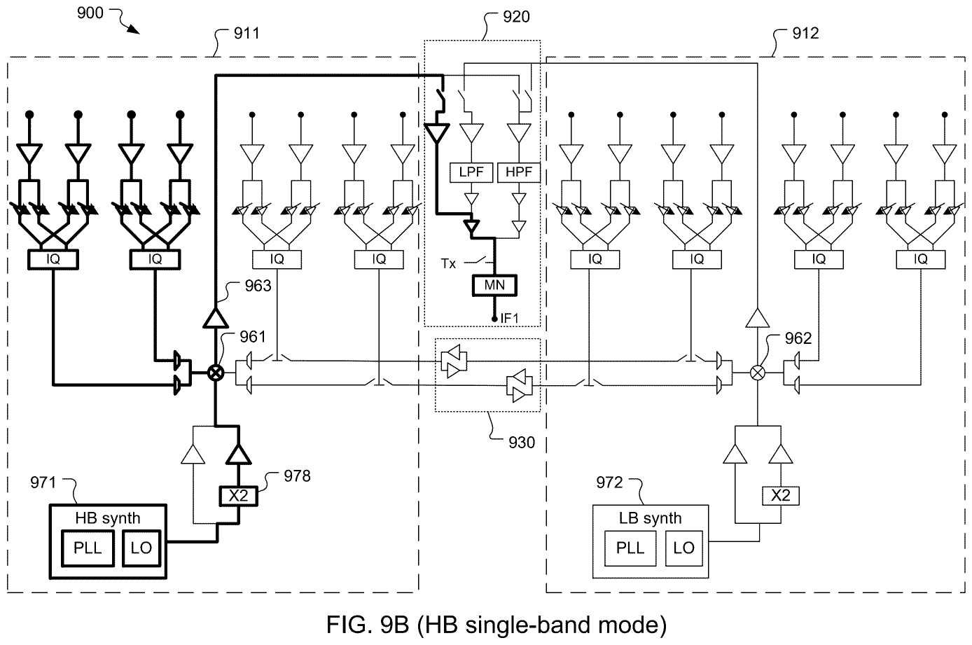

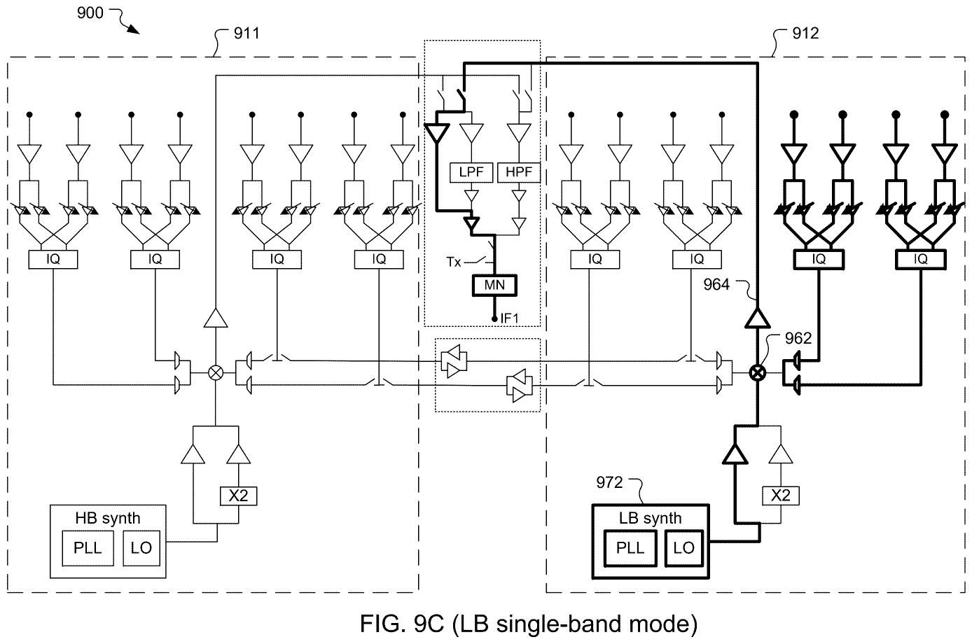

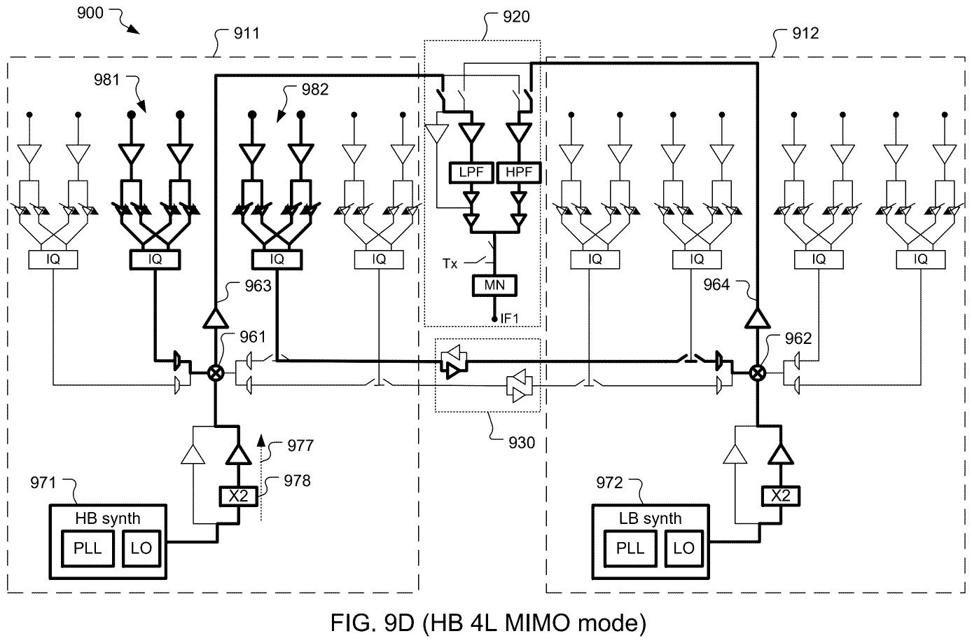

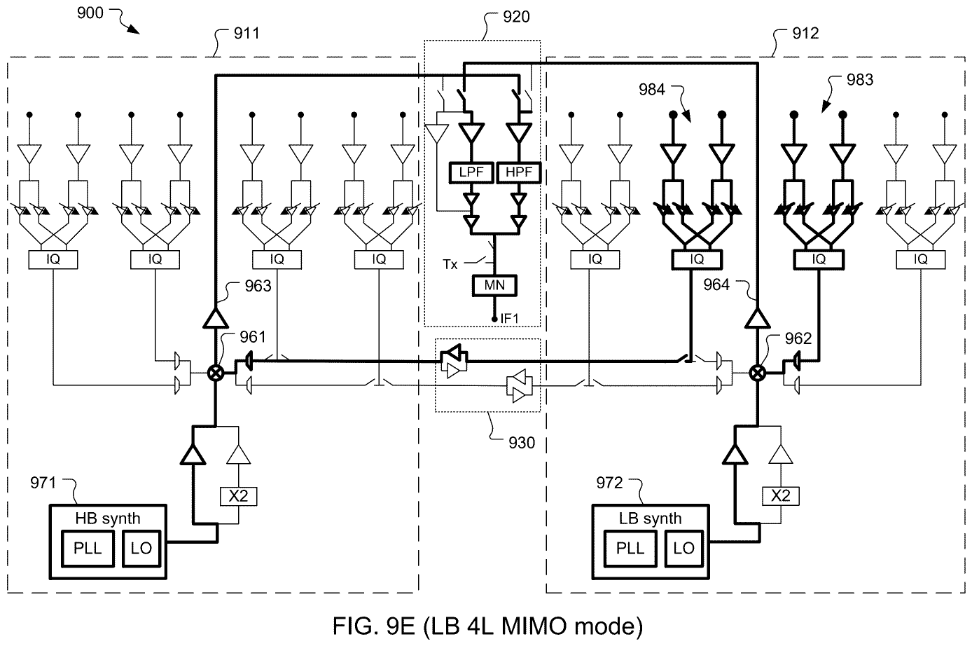

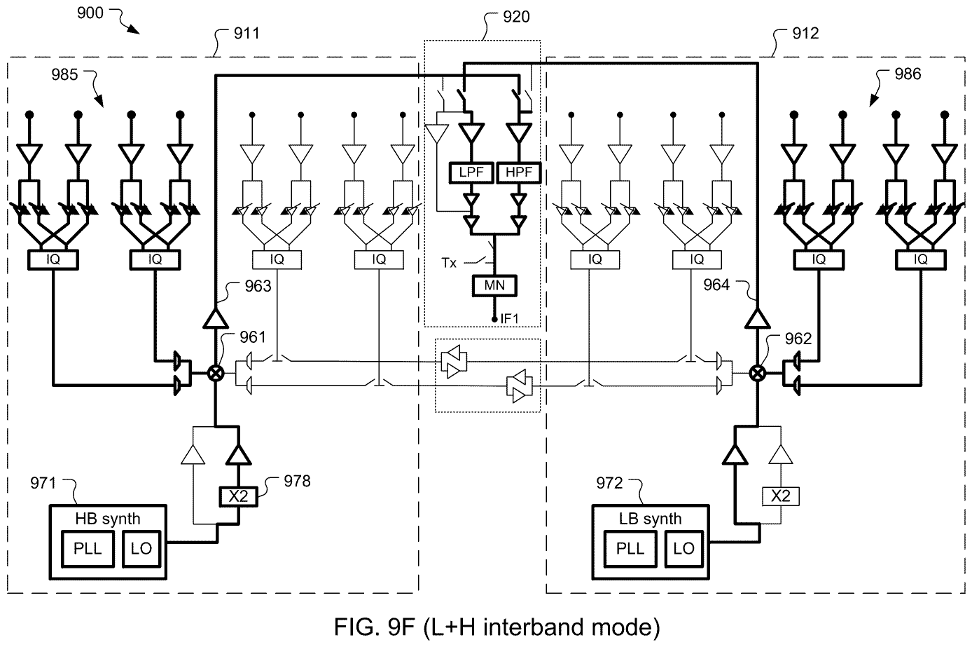

Referring also to FIG. 9A, an RF processing circuit 900 is an example of the RF processing circuit 810. The RF processing circuit 900 is configured to receive RF signals at RF ports 901, 902, convert RF signals to one or more IF signals, and provide the IF signal(s) to an IF port 980, which is an example of the IF port 820. The RF processing circuit 900 includes receiver subcircuits 911, 912, a selection circuit 920 (that is a mode-dependent, selective multiplexing, selective filtering circuit) communicatively coupled to the subcircuits 911, 912 (with the subcircuit 911 being an HB subcircuit and the subcircuit 912 being an LB subcircuit), and a cross-connection circuit 930 coupled to the subcircuits 911, 912. The RF processing circuit 900 may comprise one polarization layer, e.g., an H-pol layer or a V-pol layer, of a receiver circuit. An RF processing circuit may be provided for multiple layers, e.g., an H-pol layer and a V-pol layer, with a circuit mirroring the circuit 900 provided for the other layer and with synthesizers shared between the layers as discussed below. The RF processing circuit 900 may provide area and/or power savings, e.g., relative to the receiver 300 (e.g., by elimination of dedicated LB/HB MIMO paths, using shared IQ hybrid circuits between multiple antenna elements, eliminating some stages of the multi-stage low noise amplifiers/RF amplifiers, IF amplifiers, eliminating Wilkinson combiners, and using 4:1 active combining of current signals). For example, IQ hybrid sharing between two antenna elements may save the area of eight IQ hybrids for each band for 8E (8 elements), V+H layer and a total of 16 IQ hybrids for LB/HB bands for 16E (16 elements). Eliminating a second stage LNA (Low-Noise Amplifier) may save 16 LNA stages for 8E, V+H per band and 32 stages for LB/HB bands for 16E. Eliminating RFVGA (RF Variable Gain Amplifiers) and Wilkinson combiners per receiver subcircuit and using 4:1 combiners (e.g., as discussed below) with a shared LO (Local Oscillator) switching may save eight Wilkinson combiners for 8E, V+H and 16 combiners for LB/HB bands for 16E, and may save four RFVGA for 8E, V+H and eight RFVGA for LB/HB bands for 16E.

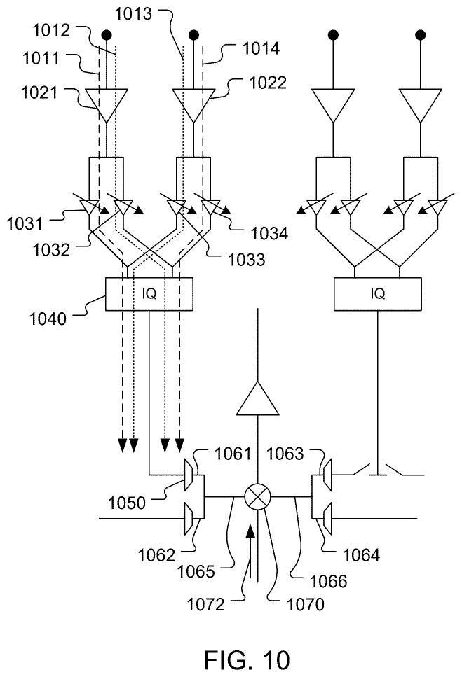

Referring also to FIG. 10, in the subcircuits 911, 912, sets of RF reception paths share an IQ hybrid circuit. For example, an RF reception path 1011 includes an low noise amplifier 1021, a variable gain amplifier 1031, and an IQ hybrid circuit 1040, an RF reception path 1012 includes the low noise amplifier 1021, a variable gain amplifier 1032, and the IQ hybrid circuit 1040, an RF reception path 1013 includes an low noise amplifier 1022, a variable gain amplifier 1033, and the IQ hybrid circuit 1040, and an RF reception path 1014 includes the low noise amplifier 1022, a variable gain amplifier 1034, and the IQ hybrid circuit 1040. The IQ hybrid circuit 1040 is thus shared by all four of the RF reception paths 1011-1014. The IQ hybrid circuit 1040 is shared between two antenna elements as an example. More antenna elements may be combined sharing the same IQ hybrid circuit 1040, depending upon the loading and signal path performance. The variable gain amplifier 1031 and the IQ hybrid circuit 1040 constitute a vector-modulator-based phase shifter.

Outputs of IQ hybrid circuits (single-ended or differential) can be converted to current signals and combined. Current combining saves die area as compared to bulky Wilkinson combiners combining in power. For example, four voltage signals (corresponding to four IQ hybrid circuits, including the IQ hybrid circuit 1040) are each converted by a respective transconductance circuit (e.g., transconductance circuit 1050) into a current signal 1061 (as opposed to a voltage signal). The current signal 1061 is combined with a current signal 1062, as are current signals 1063, 1064, to form combined current signals 1065, 1066 and the combined current signals 1065, 1066 are mixed by a mixer 1070 with a reference signal 1072 (an oscillator signal that may or may not have been multiplied). Another advantage of current combining is as follows. When switching multiple antenna elements (say N) ON, the signal from each element combines in a fully correlated manner whereas the noise from each element is uncorrelated. Hence a signal-to-noise ratio (SNR) improvement may proportional to log 10(N). By scaling the bias current of the transconductance circuit 1050 by sqrt (N), the same SNR improvement may be achieved while maintaining a constant total current through the mixer 1070 such that the performance of the mixer 1070 is independent of the number of active antenna elements.

Referring in particular again to FIG. 9A, the subcircuits 911, 912 include the ports 901, 902 for receiving RF signals (from antenna elements) and switches under control of a controller, e.g., the controller 850, that, in combination with the cross-connection circuit 930 can direct RF signals from one of the subcircuits 911, 912 to the other subcircuit of the subcircuits 911, 912. For example, for a single-band mode or L+H (low-and-high) interband CA mode, the controller 850 can cause RF signals from the IQ hybrid circuit 951 and/or RF signals from an IQ hybrid circuit 952, and/or RF signals from the IQ hybrid circuit 953 and/or RF signals from an IQ hybrid circuit 954, to be directed to a mixer 961 (via Gm combiners) to convert the RF signals (that have been converted to a single RF signal) to an IF signal. For a 4L (four layer) MIMO mode, the controller 850 may, for example, cause RF signals from the IQ hybrid circuit 952 to be mixed by the mixer 961 and provided to the selection circuit 920, and RF signals from the IQ hybrid circuit 953 to be sent to the subcircuit 912 for mixing by a mixer 962 and provision to the selection circuit 920. As another MIMO mode example, the controller 850 may cause RF signals from an IQ hybrid circuit 956 to be mixed by the mixer 962 and provided to the selection circuit 920, and RF signals from an IQ hybrid circuit 955 to be provided to the mixer 961 for mixing and provision (as an IF signal) to the selection circuit 920. For example, for 4L MB/HB MIMO, RF signals from the IQ hybrid circuit 951 may be MUXed, mixed, and directed to the selection circuit 920, and RF signals from the IQ hybrid circuit 953 may be directed through the cross-connection circuit 930 to the subcircuit 912 (for MUXing, mixing with a reference signal by the mixer 962, and provision to the selection circuit 920). The mixers 961, 962 are shared between non-MIMO and MIMO modes such that the RF processing circuit 900 does not have dedicated MIMO mixers.

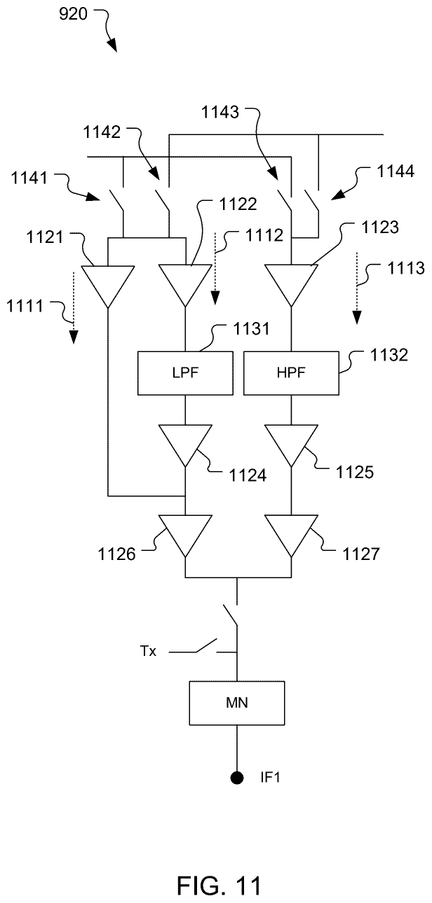

Referring also to FIG. 11, the selection circuit 920 is configured to route non-MIMO and MIMO signals appropriately. The selection circuit 920 includes three paths, a single-band path 1111 includes an IF amplifier 1121 (an no frequency filter), a first MIMO path 1112 includes an IF amplifier 1122 in series with an LPF 1131 and a buffer 1124, and a second MIMO path 1113 includes an IF amplifier 1123 in series with an HPF 1132 and a buffer 1125. The path 1111 bypasses frequency filtering. Switches 1141, 1142, 1143, 1144 are communicatively coupled to a controller (e.g., the controller 850) and configured to respond to commands from the controller to selectively couple the subcircuit(s) 911, 912 to the paths 1111-1113 depending on the operational mode of the RF processing circuit 900. Downstream of the LPF 1131, the paths 1111, 1112 merge and include a further amplifier 1126. The path 1113 also includes an amplifier 1127 downstream of the HPF 1132.

Each of the subcircuits 911, 912 includes an oscillator circuit configured to provide a reference signal (an oscillation signal) that may or may not be multiplied. For example, the subcircuit 911 includes an HB synthesizer 971 and the subcircuit 912 includes an LB synthesizer 972. The HB synthesizer 971 includes an LO 973 and a PLL 974 (Phase-Locked Loop). The HB synthesizer 971 is configured to output a reference signal 975 that may pass through a 1x frequency multiplication path 976 or a 2x frequency multiplication path 977 (although other multipliers may be used). The 2x path 977 includes a 2x multiplier 978 (a frequency doubler) configured to double a frequency of the reference signal 975. The HB synthesizer 971 may be configured to provide the reference signal 975 and the LB synthesizer 972 may be configured to provide a reference signal with a frequency that is higher than the frequency of the reference signal 975. The subcircuit 911 may share the HB synthesizer 971 with another HB subcircuit of a different polarization layer (not shown), and the subcircuit 912 may share the LB synthesizer 972 with another LB subcircuit of the different polarization layer. The HB synthesizer 971 would be considered to be part of both the subcircuit 911 and the HB subcircuit of the other layer, and the LB synthesizer 972 would be considered to be part of both the subcircuit 912 and the LB subcircuit of the other layer. That is, the HB synthesizer 971 is part of the subcircuit 911 and could be part of (and coupled to circuitry of) HB subcircuits of both of the H-pol and V-pol layers of a receiver and the LB synthesizer 972 is part of the subcircuit 912 and could be part of (and coupled to circuitry of) HB subcircuits of both of the H-pol and V-pol layers of the receiver.

Referring also to FIG. 9B, FIG. 9C, FIG. 9D, FIG. 9E, and FIG. 9F, components of the RF processing circuit 900 may be selective actuated for different modes of operation. For example, the RF processing circuit 900 may be operated in a single-band mode (either high band or low band, and which may be considered to be a form of MIMO (either HB 2L (2-layer) MIMO or LB 2L MIMO) if a single band of multiple layers (e.g., an H-pol layer and a V-pol layer) are actuated). As other examples, the RF processing circuit may be operated in an HB 4L MIMO mode, an LB 4L MIMO mode, or an L+H interband mode. In FIGS. 9B-9F, non-bold components indicate components that are not used (e.g., turned off or inhibited from receiving a signal (e.g., with one or more switches (whether shown in FIGS. 9B-9F or not) being open)), and bolded components indicate components in use (e.g., components turned on and receiving/passing a signal). A bolded switch is in use (closed), even if shown in the open position.

For HB single-band 2L operation (only 1 layer shown) as shown in FIG. 9B, a set of paths of the subcircuit 911 are actuated. RF signals of these paths are combined and routed through the mixer 961. The mixer 961 mixes the combined RF signal with a reference signal that is an oscillation signal output by the HB synthesizer 971 and doubled by the 2x multiplier 978. The frequency provided by the HB synthesizer 971 is selected such that after doubling and use by the mixer 961, an IF signal 963 that is output by the mixer 961 is in a lower IF frequency band. Using a lower-frequency IF signal helps save power compared to using (and thus routing) a higher-frequency IF signal. The IF signal 963 is routed through the path 1111 (see FIG. 11) of the selection circuit 920, thus bypassing frequency filtering.

For LB single-band 2L operation (1 layer shown) as shown in FIG. 9C, a set of paths of the subcircuit 912 are actuated. RF signals of these paths are combined and routed through the mixer 962. The mixer 962 mixes the combined RF signal with a reference signal that is an oscillation signal output by the LB synthesizer 972 and routed through a 1x path (i.e., not through a multiplier). Consequently, an IF signal 964 that is output by the mixer 962 is in a lower IF frequency band. The IF signal 964 is routed through the path 1111 (see FIG. 11) of the selection circuit 920, thus bypassing frequency filtering. The architecture of the RF processing circuit 900 provides flexibility (e.g., for co-existence/concurrency scenarios (e.g., FR1+FR2, FR2+FR3, etc.)) to move the IF frequency range to dodge jammers and improve desense. The RF processing circuit 900 allows swapping of IF ranges for LB and HB, e.g., for FR2/FR3/radar applications. A downconverted IF signal is provided on a cable to an IF IC. If a jammer in the same frequency range as the downconverted IF signal is present on the cable, then a de-sense may occur. The frequency of the downconverted signal may be moved to a different IF frequency than the jammer to avoid de-sense.

For high-band 4L MIMO operation as shown in FIG. 9D, multiple subsets of paths of the HB subcircuit 911 are actuated, with the RF signals of one of the subsets of RF paths (here, a subset 981) being combined, mixed by the mixer 961, and directed to the path 1112 of the selection circuit 920, and with the RF signals of the other of the subsets of RF paths (here, a subset 982) being combined, mixed by the mixer 962, and directed to the path 1113 of the selection circuit 920. A combined RF signal from the subset 981 is mixed by the mixer 961 with a reference signal that is an oscillation signal output by the HB synthesizer 971 and doubled by the 2x multiplier 978 such that the IF signal 963 that is output by the mixer 961 is in a lower IF frequency band. The IF signal 963 is routed through the path 1112 (see FIG. 11) of the selection circuit 920 with the LPF 1131. The RF signals from the subset 982 are routed via the cross-connection circuit 930 to the mixer 962 via a multiplexer that combines the RF signals into a combined RF signal. The combined RF signal is mixed by the mixer 962 with a reference signal that is an oscillation signal output by the LB synthesizer 972 and doubled by a 2x multiplier such that the IF signal 964 that is output by the mixer 962 is in a higher IF frequency band than the IF signal 963. The higher IF frequency band is separated from the lower IF frequency band such that the IF signals 963, 964 may be separately frequency filtered to retain the IF signals 963, 964 while rejecting signals/jammers in the other IF frequency band. The IF signal 964 is routed through the path 1113 (see FIG. 11) of the selection circuit 920 with the HPF 1132.

For low-band 4L MIMO operation as shown in FIG. 9E, multiple subsets of paths of the LB subcircuit 912 are actuated, with the RF signals of one of the subsets of RF paths (here, a subset 983) being combined, mixed by the mixer 962, and directed to the path 1112 of the selection circuit 920, and with the RF signals of the other of the subsets of RF paths (here, a subset 984) being combined, mixed by the mixer 961, and directed to the path 1113 of the selection circuit 920. A combined RF signal from the subset 983 is mixed by the mixer 962 with a reference signal that is an oscillation signal output by the LB synthesizer 972 and passed without frequency multiplication to the mixer 962 such that the IF signal 964 that is output by the mixer 962 is in a lower IF frequency band. The IF signal 964 is routed through the path 1112 (see FIG. 11) of the selection circuit 920 with the LPF 1131. The RF signals from the subset 984 are routed via the cross-connection circuit 930 to the mixer 961 via a multiplexer that combines the RF signals into a combined RF signal. The combined RF signal is mixed by the mixer 961 with a reference signal that is an oscillation signal output by the HB synthesizer 971 and provided without frequency multiplication to the mixer 961 such that the IF signal 963 that is output by the mixer 961 is in a higher IF frequency band than the IF signal 964. The higher IF frequency band is separated from the lower IF frequency band such that the IF signals 963, 964 may be separately frequency filtered to retain the IF signals 963, 964 while rejecting signals/jammers in the other IF frequency band. The IF signal 963 is routed through the path 1113 (see FIG. 11) of the selection circuit 920 with the HPF 1132.

For interband CA (Carrier Aggregation) operation as shown in FIG. 9F, a set of paths of the HB subcircuit 911 and a set of paths of the LB subcircuit 912 are actuated, with the RF signals from the HB subcircuit 911 (here, a subset 985) being combined, mixed by the mixer 961, and directed to the path 1113 of the selection circuit 920, and with the RF signals of the subcircuit 912 (here, a subset 986) being combined, mixed by the mixer 962, and directed to the path 1112 of the selection circuit 920. A combined RF signal from the subset 985 is mixed by the mixer 961 with a reference signal that is an oscillation signal output by the HB synthesizer 971 and doubled by the 2x multiplier 978. The frequency provided by the HB synthesizer 971 is selected such that after doubling and use by the mixer 961, the IF signal 963 that is output by the mixer 961 is in a higher IF frequency band. A combined RF signal from the subset 986 is mixed by the mixer 962 with a reference signal that is an oscillation signal output by the LB synthesizer 972 and provided to the mixer 962 without frequency multiplication. The frequency provided by the LB synthesizer 972 is selected such that after use by the mixer 962, the IF signal 964 that is output by the mixer 962 is in a lower IF frequency band.

Referring again to FIG. 12, and with reference to Table 1 below, IF frequencies in different modes of operation of the receiver 300 and the RF processing circuit 900 are shown.

TABLE 1

| | Single | HB 4L | Interband | LB 4L |
|---|---|---|---|---|
| Mixer | band 2L | MIMO | CA | MIMO |
| HB mixer | Lower IF | Lower IF | Higher IF | Higher IF |
| LB mixer | Lower IF | Higher IF | Lower IF | Lower IF |

For LB 2-layer operation and HB 2-layer operation, the frequencies of the IF signals produced are all in low IF frequency ranges (which may be the same frequency range), to save power. For HB 4L MIMO operation using the RF processing circuit 900, the frequency of the IF signal 963 is in a lower IF frequency range 1210 instead of in a higher IF frequency range 1220, as with the receiver 300, and the IF signal 964 is in a higher frequency range. Consequently, the operational mode of the RF processing circuit 900 may be switched between HB 2L operation and HB 4L operation quickly, e.g., while meeting a stringent settling-time requirement, e.g., by avoiding large changes in a reference clock signal and RFPLL/IFPLLs provided to the RF processing circuit 900 (e.g., by the IF IC 860) to maintain the IF frequency range. Also, this arrangement helps maintain the phase continuity on the initial two layers without disturbing the peak throughput due to the addition of two more layers. A switch between HB single band 2L and HB 4L MIMO can be made without reconfiguring a filter (from low pass to high pass), and instead changing which path of the selection circuit 920 is used. For LB 4L MIMO operation, the IF signal 964 is in the lower frequency range 1210 and the IF signal 963 is in the higher frequency range. For L+H interband CA operation, the IF signal 964 is in the lower frequency range 1210 and the IF signal 963 is in the higher frequency range 1220. From FIG. 12 and Table 1 it can be seen that during single-band mode, an IF signal in the lower frequency range 1210 is produced (by the mixer 961 or the mixer 962) to save power, and when a change is made to a MIMO mode (from HB single band 2L to HB 4L MIMO, or from LB single band 2L to LB 4L MIMO), the in-use mixer for 2L continues to produce a lower-frequency IF signal and the other (newly-used for added 2 layers) mixer produces a higher-frequency IF signal.

The RF processing circuit 900 has various physical attributes. For example, a single mixer may be used for each subcircuit, e.g., the mixer 961 for the subcircuit 911 and the mixer 962 for the subcircuit 912, and thus exactly two mixers for an entire layer. Use of a single mixer per polarization/frequency-band subcircuit may help conserve area for the circuitry of an RF processing circuit. As another example, RF routing circuitry is provided for routing RF signals from one side of an IC chip containing an RF processing circuit (e.g., a low-band side) to the other side of the chip (e.g., a high-band side). The RF routing circuitry includes the cross-connection circuit 930 that provides RF routing crossover and is disposed in a middle (overlying a midpoint) of the RF processing circuit 900 (e.g., over a midpoint of a length of an IC chip containing the RF processing circuit 900, e.g., an IC chip containing the RF processing circuit 810). In some examples, there is no dedicated mixer for MIMO operation. The same mixer, e.g., the mixer 961 or the mixer 962, may be used for different modes of operation including one or more non-MIMO modes and one or more MIMO modes. As another example, IQ hybrids are disposed downstream of variable gain amplifiers. As another example, local oscillator signals are contained to respective halves of the IC chip containing the RF processing circuit (and not conveyed from one side of the chip (e.g., a low-band side) to the other side of the chip (e.g., a high-band side).

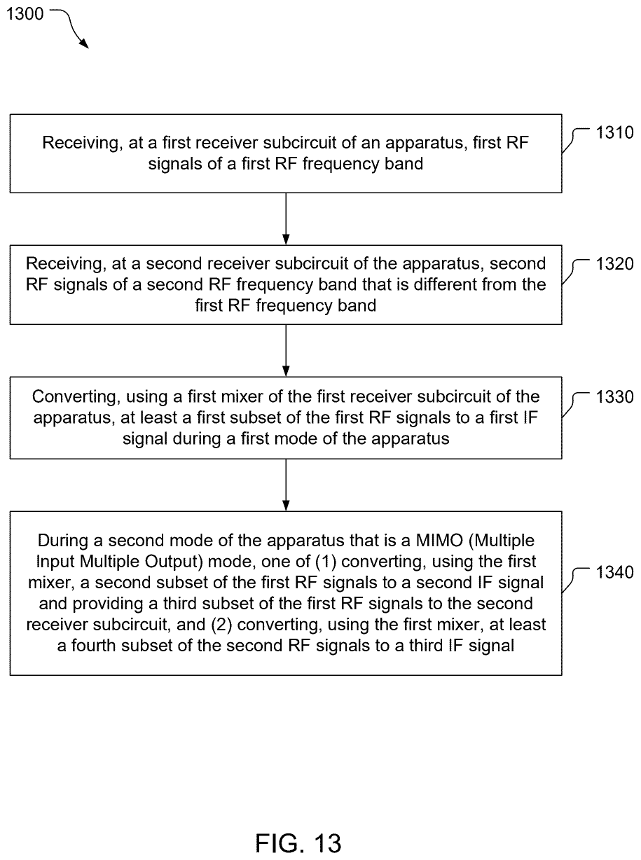

Referring to FIG. 13, with further reference to FIGS. 8-12, a method 1300 of converting RF signals to IF signals includes the stages shown. The method 1300 is, however, an example only and not limiting. The method 1300 may be altered, e.g., by having one or more stages added, removed, rearranged, combined, performed concurrently, and/or by having one or more single stages split into multiple stages.

At stage 1310, the method 1300 includes receiving, at a first receiver subcircuit of an apparatus, first RF signals of a first RF frequency band. For example, the first receiver subcircuit 830 (e.g., the subcircuit 911 or the subcircuit 912) may receive RF signals, e.g., via the first RF ports 834 (e.g., the ports 901) in a first frequency band (e.g., between 24.25 GHz and 27.5 GHz or between 37 GHz and 48 GHz for FR2). The first receiver subcircuit 830 (e.g., the first RF ports 834) may comprise means for receiving the first RF signals.

At stage 1320, the method 1300 includes receiving, at a second receiver subcircuit of an apparatus, second RF signals of a second RF frequency band. For example, the second receiver subcircuit 840 (e.g., the subcircuit 912 or the subcircuit 911) may receive RF signals, e.g., via the second RF ports 844 (e.g., the ports 902) in a second frequency band (e.g., between 37 GHz and 48 GHz or between 24.25 GHz and 27.5 GHz for FR2). The second receiver subcircuit 840 (e.g., the second RF ports 844) may comprise means for receiving the second RF signals.

At stage 1330, the method 1300 includes converting, using a first mixer of the first receiver subcircuit of the apparatus, at least a first subset of the first RF signals to a first IF signal during a first mode of the apparatus. For example, during a single-band operation mode, the first mixer 832 (e.g., the mixer 961 for an HB single-band mode or the mixer 962 for an LB single-band mode) may mix a combined RF signal (based on the received first RF signals) to the IF signal 963 or the IF signal 964. The first mixer 832 may comprise means for converting the first subset of the first RF signals to a first IF signal.

At stage 1340, the method 1300 includes during a second mode of the apparatus that is a MIMO (Multiple Input Multiple Output) mode, one of (1) converting, using the first mixer, a second subset of the first RF signals to a second IF signal and providing a third subset of the first RF signals to the second receiver subcircuit, and (2) converting, using the first mixer, at least a fourth subset of the second RF signals to a third IF signal. For example, during the HB 4L MIMO mode (e.g., as shown in FIG. 9D) the first mixer 832 may convert some of the first RF signals to a second IF signal (e.g., the mixer 961 may convert RF signals from the subset 981 to the IF signal 963) or during the LB 4L MIMO mode (e.g., as shown in FIG. 9E) the first mixer 832 may convert signals from the second receiver subcircuit 840 (e.g., the mixer 961 may convert RF signals from the subset 984 to the IF signal 963). As another example, during the LB 4L MIMO mode (e.g., as shown in FIG. 9E) the first mixer 832 may convert some of the second RF signals to a second IF signal (e.g., the mixer 962 may convert RF signals from the subset 983 to the IF signal 964) or during the HB 4L MIMO mode (e.g., as shown in FIG. 9D) the first mixer 832 may convert signals from the first receiver subcircuit 830 (e.g., the mixer 962 may convert RF signals from the subset 982 to the IF signal 964).

Implementations of the method 1300 may include one or more of the following features. In an example implementation, during the second mode, the at least the fourth subset of the second RF signals is converted by the first mixer to the third IF signal, the method further comprising: providing a first oscillator signal, of a first frequency, to the first mixer during the first mode; and providing a second oscillator signal, of a second frequency that is different from the first frequency, to the first mixer during the second mode. For example, during HB single-band mode (or HB 4L MIMO mode) and LB 4L MIMO mode, the first mixer 832 (e.g., the mixer 961) is supplied with reference signals of different frequencies (e.g., via the path 977 for HB single band or HB 41 MIMO modes, and via the path 976 for LB 4L MIMO mode). As another example, during LB single-band mode (or LB 4L MIMO mode) and HB 4L MIMO mode, the first mixer 832 (e.g., the mixer 962) is supplied with reference signals of different frequencies (e.g., via the 1x path between the LB synthesizer 972 and the mixer 962 for LB single band or LB 4L MIMO modes, and via the 2x path for HB 4L MIMO mode). The paths 976, 977, in combination with the HB synthesizer 971 and the controller 850 (e.g., the processor 852 possibly in combination with the memory 854) may comprise means for providing the first and second oscillator signals. Alternatively, the 1x and 2x paths between the LB synthesizer 972, and the LB synthesizer 972 and the controller 850 may comprise means for providing the first and second oscillator signals. The remaining discussion of the method 1300 focuses on examples where the first mixer is the mixer 961, but as with the above discussion of the method 1300, the mixer 962 may be used as the first mixer.

Also or alternatively, implementations of the method 1300 may include one or more of the following features. In an example implementation, the method 1300 includes: routing, during the first mode, the first IF signal to an IF port of the apparatus without frequency filtering the first IF signal; and routing, during the second mode, one of the second IF signal to the IF port via a first frequency filter and the third IF signal to the IF port via a second frequency filter. For example, during the HB single-band mode shown in FIG. 9B, the IF signal 963 may be routed through the path 1111 (see FIG. 11) without frequency filtering the IF signal 963 (bypassing the LPF 1131 and the HPF 1132). The controller 850 and the switch 1141 may comprise means for routing the first IF signal during the first mode. As another example, during the HB 4L MIMO mode, the IF signal 963 may be routed through the path 1112 and the IF signal 964 may be routed through the path 1113. The controller 850 and the switches 1141, 1144 may comprise means for routing the second IF signal and the third IF signal during the first mode. As another example, during the L+H interband mode shown in FIG. 9F, the IF signal 963 may be routed through the path 1113 and the IF signal 964 may be routed through the path 1112. The controller 850 and the switches 1142, 1143 may comprise means for routing the second IF signal and the third IF signal during the first mode. In a further example implementation, the second mode comprises converting, using the first mixer, the second subset of the first RF signals to the second IF signal and providing the third subset of the first RF signals to the second receiver subcircuit, the method 1300 further includes: converting the third subset of the first RF signals to a fourth IF signal; providing a first oscillator signal to the first mixer during the first mode and during the second mode such that the first IF signal and the second IF signal are both within a lower-IF frequency band; and providing a third oscillator signal to a second mixer of the second receiver subcircuit during the second mode such that the fourth IF signal is in a higher-IF frequency band that is higher than the lower-IF frequency band. For example, in the HB 4L MIMO mode shown in FIG. 9D, RF signals from the subset 982 are converted to the IF signal 964 (after being combined by a multiplexer). During the HB single-band mode and the HB 4L MIMO mode, a reference signal is provided via the path 977 to the mixer 961 (even if a signal output by the HB synthesizer 971 in the different mode is slightly different in frequency) such that the IF signal 963 in both modes has a frequency in the lower frequency range 1210. Further, during the HB 4L MIMO mode, the reference signal provided to the mixer 962 form the LB synthesizer 972 is provided through the 2x multiplier path between the LB synthesizer 972 and the mixer 962 such that the IF signal 964 has a frequency in the higher frequency range 1220. The mixer 962 (possibly in combination with a multiplexer) may comprise means for converting the third subset of first RF signals to the fourth IF signal. The HB synthesizer 971 and the path 977 may comprise means for providing the first oscillator signal to the first mixer during the first and second modes. The LB synthesizer 972 and the corresponding 2× multiplier path (similar to the path 977) may comprise means for providing the third oscillator signal to the second mixer. In a further example implementation, the first frequency filter is a low-pass frequency filter and the second frequency filter is a high-pass frequency filter.

Also or alternatively, implementations of the method 1300 may include one or more of the following features. In an example implementation, the method 1300 includes: converting, using the first mixer of the first receiver subcircuit of the apparatus, at least a fifth subset of the first RF signals to a fifth IF signal during a third mode of the apparatus; converting, using a second mixer of the second receiver subcircuit of the apparatus, at least a sixth subset of the second RF signals to a sixth IF signal during the third mode; routing, during the third mode, the fifth IF signal to an IF port of the apparatus via a first frequency filter configured to pass signals in a first IF frequency band and to reject signals in a second IF frequency band; and routing, during the third mode, the sixth IF signal to the IF port via a second frequency filter configured to reject signals in the first IF frequency band and to pass signals in the second IF frequency band. For example, during the L+H interband mode shown in FIG. 9F, RF signals from the subset 985 may be converted by the mixer 961 to the IF signal 963 and the IF signal 963 routed to the path 1113 with the HPF 1132, and RF signals from the subset 986 may be converted by the mixer 962 to the IF signal 964 and the IF signal 964 routed to the path 1112 with the LPF 1131. The mixer 961 may comprise means for converting the fifth subset of the first RF signals. The mixer 962 may comprise means for converting the sixth subset of the second RF signals. The switches 1141-1144, possibly in conjunction with the controller 850, may comprise means for routing the fifth IF signal to the IF port 980 and means for routing the sixth IF signal to the IF port 980. In another example implementation, converting, using the first mixer of the first receiver subcircuit of the apparatus, at least the first subset of the first RF signals to the first IF signal includes: converting voltage signals corresponding to the at least the first subset of the RF signals into current signals; combining the current signals into a combined signal; and mixing, by the first mixer, the combined signal with a reference signal. For example, voltage signals from the IQ hybrid circuit 1040 may be converted by the multiplexer 1050 into a current signal 1061, the current signal 1061 combined with the current signal 1062 into a combined current signal 1063, and the combined current signal 1063 mixed with the reference signal 1072. The multiplexers 1050 may comprise means for converting voltage signals to current signals. Output lines of the multiplexers 1050 may comprise means for combining the current signals into a combined current signal, and the mixer 1070 may comprise means for mixing the combined current signal.

### Implementation Examples

Implementation examples are provided in the following numbered clauses.
Clause 1. A method of converting radio frequency (RF) signals to intermediate frequency (IF) signals, the method comprising:
   receiving, at a first receiver subcircuit of an apparatus, first RF signals of a first RF frequency band;
   receiving, at a second receiver subcircuit of the apparatus, second RF signals of a second RF frequency band that is different from the first RF frequency band;
   converting, using a first mixer of the first receiver subcircuit of the apparatus, at least a first subset of the first RF signals to a first IF signal during a first mode of the apparatus; and
   during a second mode of the apparatus that is a MIMO (Multiple Input Multiple Output) mode, one of (1) converting, using the first mixer, a second subset of the first RF signals to a second IF signal and providing a third subset of the first RF signals to the second receiver subcircuit, and (2) converting, using the first mixer, at least a fourth subset of the second RF signals to a third IF signal.
Clause 2. The method of clause 1, wherein during the second mode, the at least the fourth subset of the second RF signals is converted by the first mixer to the third IF signal, the method further comprising:
   providing a first oscillator signal, of a first frequency, to the first mixer during the first mode; and
   providing a second oscillator signal, of a second frequency that is different from the first frequency, to the first mixer during the second mode.
Clause 3. The method of either clause 1 or clause 2, further comprising:
   routing, during the first mode, the first IF signal to an IF port of the apparatus without frequency filtering the first IF signal; and
   routing, during the second mode, one of the second IF signal to the IF port via a first frequency filter and the third IF signal to the IF port via a second frequency filter.
Clause 4. The method of any of clauses 1-3, wherein the second mode comprises converting, using the first mixer, the second subset of the first RF signals to the second IF signal and providing the third subset of the first RF signals to the second receiver subcircuit, the method further comprising:
   converting the third subset of the first RF signals to a fourth IF signal;
   providing a first oscillator signal to the first mixer during the first mode and during the second mode such that the first IF signal and the second IF signal are both within a lower-IF frequency band; and
   providing a third oscillator signal to a second mixer of the second receiver subcircuit during the second mode such that the fourth IF signal is in a higher-IF frequency band that is higher than the lower-IF frequency band.
Clause 5. The method of clause 4, wherein the first frequency filter is a low-pass frequency filter and the second frequency filter is a high-pass frequency filter.
Clause 6. The method of any of clauses 1-5, further comprising:
   converting, using the first mixer of the first receiver subcircuit of the apparatus, at least a fifth subset of the first RF signals to a fifth IF signal during a third mode of the apparatus;
   converting, using a second mixer of the second receiver subcircuit of the apparatus, at least a sixth subset of the second RF signals to a sixth IF signal during the third mode;
   routing, during the third mode, the fifth IF signal to an IF port of the apparatus via a first frequency filter configured to pass signals in a first IF frequency band and to reject signals in a second IF frequency band; and
   routing, during the third mode, the sixth IF signal to the IF port via a second frequency filter configured to reject signals in the first IF frequency band and to pass signals in the second IF frequency band.
Clause 7. The method of any of clauses 1-6, wherein converting, using the first mixer of the first receiver subcircuit of the apparatus, at least the first subset of the first RF signals to the first IF signal comprises:
   converting voltage signals corresponding to the at least the first subset of the first RF signals into current signals;
   combining the current signals into a combined signal; and
   mixing, by the first mixer, the combined signal with a reference signal.
Clause 8. A radio frequency (RF) signal processing circuit comprising:
   an intermediate frequency (IF) port; and
   a first receiver subcircuit communicatively coupled to the IF port and configured to receive first RF signals, of a first RF frequency band, from first antenna elements, the first receiver subcircuit including a first mixer;
   a second receiver subcircuit communicatively coupled to the IF port and configured to receive second RF signals, of a second RF frequency band that is different from the first RF frequency band, from second antenna elements;
   a controller, communicatively coupled to the first receiver subcircuit, configured to:
   cause, during a first mode of the RF signal processing circuit, the first mixer to convert at least a first subset of the first RF signals to a first IF signal; and
   cause, during a second mode of the RF signal processing circuit that is a MIMO (Multiple Input Multiple Output) mode, one of (1) the first mixer to convert a second subset of the first RF signals to a second IF signal and the first receiver subcircuit to provide a third subset of the first RF signals to the second receiver subcircuit, and (2) the first mixer to convert at least a fourth subset of the second RF signals to a third IF signal.
Clause 9. The RF signal processing circuit of clause 8, wherein the controller is configured to cause, during the second mode, the first mixer to convert the at least the fourth subset of the second RF signals to the third IF signal, the RF signal processing circuit further comprising an RF amplifying and coupling circuit coupled to the first receiver subcircuit and the second receiver subcircuit, and wherein the controller is configured to cause, during the second mode, the second receiver subcircuit to amplify and provide the third subset of the second RF signals to the first mixer via the RF amplifying and coupling circuit.
Clause 10. The RF signal processing circuit of either clause 8 or clause 9, wherein the first receiver subcircuit comprises a first oscillator circuit communicatively coupled to the first mixer and configured to selectively provide a first oscillator signal, of a first frequency, and a second oscillator signal, of a second frequency that is different from the first frequency, to the first mixer, wherein the controller is configured to cause the first oscillator circuit to provide the first oscillator signal to the first mixer during the first mode and to cause the first oscillator circuit to provide the second oscillator signal to the first mixer during the second mode.
Clause 11. The RF signal processing circuit of any of clauses 8-10, further comprising intermediate frequency routing circuitry communicatively coupled between the first receiver subcircuit and the IF port, the intermediate frequency routing circuitry including a first path without a frequency filter, a second path with a first frequency filter, and a third path with a second frequency filter, wherein the controller is communicatively coupled to the intermediate frequency routing circuitry and configured to cause, during the first mode, the first IF signal to pass through the first path and to cause, during the second mode, one of the second IF signal to pass through the second path and the third IF signal to pass through the third path.
Clause 12. The RF signal processing circuit of any of clauses 8-11, wherein:
   the controller is configured to cause, during the second mode, the first mixer to convert the second subset of the first RF signals to the second IF signal and the first receiver subcircuit to provide the third subset of the first RF signals to the second receiver subcircuit;
   the first receiver subcircuit comprises a first oscillator circuit communicatively coupled to the first mixer and configured to selectively provide a first oscillator signal, of a first frequency, and a second oscillator signal, of a second frequency that is different from the first frequency;
   the second receiver subcircuit further comprises a second oscillator circuit communicatively coupled to a second mixer that is configured to convert the third subset of first RF signals to a fourth IF signal;
   the controller is configured to cause the first oscillator circuit to provide the first oscillator signal to the first mixer during the first mode and during the second mode such that the first IF signal and the second IF signal are both within a lower-IF frequency band; and
   the controller is configured to cause, during the second mode, the second oscillator circuit to provide a third oscillator signal to the second mixer such that the fourth IF signal is in a higher-IF frequency band that is higher than the lower-IF frequency band.
Clause 13. The RF signal processing circuit of clause 12, wherein the first frequency filter is a low-pass frequency filter and the second frequency filter is a high-pass frequency filter.
Clause 14. The RF signal processing circuit of any of clauses 8-13, wherein:
   the second receiver subcircuit further comprises a second mixer;
   the RF signal processing circuit further comprises intermediate frequency routing circuitry communicatively coupled to the first receiver subcircuit and the second receiver subcircuit; and
   the controller is configured to:
   cause the first mixer to convert at least a fifth subset of the first RF signals to a fifth IF signal during a third mode of the RF signal processing circuit;
   cause the second mixer to convert at least a sixth subset of the second RF signals to a sixth IF signal during the third mode;
   cause the intermediate frequency routing circuitry, during the third mode, to route the fifth IF signal to the IF port via a first frequency filter configured to pass signals in a first IF frequency band and to reject signals in a second IF frequency band; and
   use the intermediate frequency routing circuitry, during the third mode, to route the sixth IF signal to the IF port via a second frequency filter configured to reject signals in the first IF frequency band and to pass signals in the second IF frequency band.
Clause 15. The RF signal processing circuit of any of clauses 8-14, wherein the first receiver subcircuit includes multiplexers communicatively coupled to the first mixer and configured to receive respective ones of the first RF signals as voltage signals and to output current signals, wherein the first mixer is configured to mix the current signals.
Clause 16. A radio frequency (RF) signal processing circuit for converting RF signals to intermediate frequency (IF) signals, the RF signal processing circuit comprising:
   means for receiving first RF signals of a first RF frequency band;
   means for receiving second RF signals of a second RF frequency band that is different from the first RF frequency band;
   first-mode means for converting, using a first mixer, at least a first subset of the first RF signals to a first IF signal during a first mode of the RF signal processing circuit; and
   second-mode means, during a second mode of the RF signal processing circuit that is a MIMO (Multiple Input Multiple Output) mode, one of (1) converting, using the first mixer, a second subset of the first RF signals to a second IF signal and providing a third subset of the first RF signals to the means for receiving the second RF signals, and (2) converting, using the first mixer, at least a fourth subset of the second RF signals to a third IF signal.
Clause 17. The RF signal processing circuit of clause 16, wherein the first-mode means are for, during the second mode, converting the at least the fourth subset of the second RF signals by the first mixer to the third IF signal, the RF signal processing circuit further comprising:
   means for providing a first oscillator signal, of a first frequency, to the first mixer during the first mode; and
   means for providing a second oscillator signal, of a second frequency that is different from the first frequency, to the first mixer during the second mode.
Clause 18. The RF signal processing circuit of either clause 16 or clause 17, further comprising:
   means for routing, during the first mode, the first IF signal to an IF port of the RF signal processing circuit without frequency filtering the first IF signal; and
   means for routing, during the second mode, one of the second IF signal to the IF port via a first frequency filter and the third IF signal to the IF port via a second frequency filter.
Clause 19. The RF signal processing circuit of any of clauses 16-18, wherein the second-mode means are for converting, using the first mixer, the second subset of the first RF signals to the second IF signal and providing the third subset of the first RF signals to the means for receiving the second RF signals, the RF signal processing circuit further comprising:
   means for converting the third subset of the first RF signals to a fourth IF signal;
   means for providing a first oscillator signal to the first mixer during the first mode and during the second mode such that the first IF signal and the second IF signal are both within a lower-IF frequency band; and means for providing a third oscillator signal to a second mixer of the means for receiving the second RF signals during the second mode such that the fourth IF signal is in a higher-IF frequency band that is higher than the lower-IF frequency band.
Clause 20. The RF signal processing circuit of clause 19, wherein the first frequency filter is a low-pass frequency filter and the second frequency filter is a high-pass frequency filter.
Clause 21. The RF signal processing circuit of any of clauses 16-20, further comprising:
   third-mode means for converting, using the first mixer, at least a fifth subset of the first RF signals to a fifth IF signal during a third mode of the RF signal processing circuit;
   means for converting, using a second mixer, at least a sixth subset of the second RF signals to a sixth IF signal during the third mode;
   means for routing, during the third mode, the fifth IF signal to an IF port of the RF signal processing circuit via a first frequency filter configured to pass signals in a first IF frequency band and to reject signals in a second IF frequency band; and
   means for routing, during the third mode, the sixth IF signal to the IF port via a second frequency filter configured to reject signals in the first IF frequency band and to pass signals in the second IF frequency band.
Clause 22. The RF signal processing circuit of any of clauses 16-21, wherein the first-mode means are for:
   converting voltage signals corresponding to the at least the first subset of the RF signals into current signals; and
   combining the current signals into a combined signal;
   wherein the first mixer is configured to mix the combined signal with a reference signal.
Clause 23. A non-transitory, processor-readable storage medium comprising processor-readable instructions to cause at least one processor of a radio frequency (RF) signal processing circuit, that includes: an intermediate frequency (IF) port; a first receiver subcircuit communicatively coupled to the IF port and configured to receive first RF signals, of a first RF frequency band, from first antenna elements, the first receiver subcircuit including a first mixer; and a second receiver subcircuit communicatively coupled to the IF port and configured to receive second RF signals, of a second RF frequency band that is different from the first RF frequency band, from second antenna elements, to:
   cause, during a first mode of the RF signal processing circuit, the first mixer to convert at least a first subset of the first RF signals to a first IF signal; and
   cause, during a second mode of the RF signal processing circuit that is a MIMO (Multiple Input Multiple Output) mode, one of (1) the first mixer to convert a second subset of the first RF signals to a second IF signal and the first receiver subcircuit to provide a third subset of the first RF signals to the second receiver subcircuit, and (2) the first mixer to convert at least a fourth subset of the second RF signals to a third IF signal.
Clause 24. The non-transitory, processor-readable storage medium of clause 23, wherein the processor-readable instructions include processor-readable instructions to cause the at least one processor to cause, during the second mode, the first mixer to convert the at least the fourth subset of the second RF signals by the first mixer to the third IF signal, the non-transitory, processor-readable storage medium further comprising processor-readable instructions to cause the at least one processor to:
   cause a first oscillator circuit of the first receiver subcircuit to provide a first oscillator signal, of a first frequency, to the first mixer during the first mode; and
   cause a second oscillator circuit of the second receiver subcircuit to provide a second oscillator signal, of a second frequency that is different from the first frequency, to the first mixer during the second mode.
Clause 25. The non-transitory, processor-readable storage medium of either clause 23 or clause 24, further comprising processor-readable instructions to cause the at least one processor to:
   cause IF routing circuitry to route, during the first mode, the first IF signal to the IF port without frequency filtering the first IF signal; and
   cause the IF routing circuitry to route, during the second mode, one of the second IF signal to the IF port via a first frequency filter and the third IF signal to the IF port via a second frequency filter.
Clause 26. The non-transitory, processor-readable storage medium of any of clauses 23-25, wherein the processor-readable instructions include processor-readable instructions to cause the at least one processor to cause the first mixer to convert the second subset of the first RF signals to the second IF signal and to provide the third subset of the first RF signals to the second receiver subcircuit, the non-transitory, processor-readable storage medium further comprising processor-readable instructions to cause the at least one processor to:
   cause the second receiver subcircuit to convert the third subset of the first RF signals to a fourth IF signal;
   cause a first oscillator circuit to provide a first oscillator signal to the first mixer during the first mode and during the second mode such that the first IF signal and the second IF signal are both within a lower-IF frequency band; and
   cause a second oscillator circuit to provide a third oscillator signal to a second mixer of the second receiver subcircuit during the second mode such that the fourth IF signal is in a higher-IF frequency band that is higher than the lower-IF frequency band.
Clause 27. The non-transitory, processor-readable storage medium of any of clauses 23-26, further comprising processor-readable instructions to cause the at least one processor to:
   cause the first mixer to convert at least a fifth subset of the first RF signals to a fifth IF signal during a third mode of the RF signal processing circuit;
   cause a second mixer of the second receiver subcircuit to convert at least a sixth subset of the second RF signals to a sixth IF signal during the third mode;
   cause IF routing circuitry of the RF signal processing circuit to route, during the third mode, the fifth IF signal to an IF port of the RF signal processing circuit via a first frequency filter configured to pass signals in a first IF frequency band and to reject signals in a second IF frequency band; and
   cause the IF routing circuitry to route, during the third mode, the sixth IF signal to the IF port via a second frequency filter configured to reject signals in the first IF frequency band and to pass signals in the second IF frequency band.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, the components may be directly or indirectly connected to enable signal transfer between the components. Communicative coupling includes selective communicative coupling, e.g., components each being coupled to a switch that may be controlled to open to isolate the components or be controlled to close to complete (at least a portion of) a connection between the components.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of +20% or +10%, +5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of converting radio frequency (RF) signals to intermediate frequency (IF) signals, the method comprising:
receiving, at a first receiver subcircuit of an apparatus, first RF signals of a first RF frequency band;
receiving, at a second receiver subcircuit of the apparatus, second RF signals of a second RF frequency band that is different from the first RF frequency band;
converting, using a first mixer of the first receiver subcircuit of the apparatus, at least a first subset of the first RF signals to a first IF signal during a first mode of the apparatus; and
during a second mode of the apparatus that is a MIMO (Multiple Input Multiple Output) mode, one of (1) converting, using the first mixer, a second subset of the first RF signals to a second IF signal and providing a third subset of the first RF signals to the second receiver subcircuit, and (2) converting, using the first mixer, at least a fourth subset of the second RF signals to a third IF signal.

2. The method of claim 1, wherein during the second mode, the at least the fourth subset of the second RF signals is converted by the first mixer to the third IF signal, the method further comprising:
providing a first oscillator signal, of a first frequency, to the first mixer during the first mode; and
providing a second oscillator signal, of a second frequency that is different from the first frequency, to the first mixer during the second mode.

3. The method of claim 1, further comprising:
routing, during the first mode, the first IF signal to an IF port of the apparatus without frequency filtering the first IF signal; and
routing, during the second mode, one of the second IF signal to the IF port via a first frequency filter and the third IF signal to the IF port via a second frequency filter.

4. The method of claim 3, wherein the second mode comprises converting, using the first mixer, the second subset of the first RF signals to the second IF signal and providing the third subset of the first RF signals to the second receiver subcircuit, the method further comprising:
converting the third subset of the first RF signals to a fourth IF signal;
providing a first oscillator signal to the first mixer during the first mode and during the second mode such that the first IF signal and the second IF signal are both within a lower-IF frequency band; and
providing a third oscillator signal to a second mixer of the second receiver subcircuit during the second mode such that the fourth IF signal is in a higher-IF frequency band that is higher than the lower-IF frequency band.

5. The method of claim 4, wherein the first frequency filter is a low-pass frequency filter and the second frequency filter is a high-pass frequency filter.

6. The method of claim 1, further comprising:
converting, using the first mixer of the first receiver subcircuit of the apparatus, at least a fifth subset of the first RF signals to a fifth IF signal during a third mode of the apparatus;
converting, using a second mixer of the second receiver subcircuit of the apparatus, at least a sixth subset of the second RF signals to a sixth IF signal during the third mode;
routing, during the third mode, the fifth IF signal to an IF port of the apparatus via a first frequency filter configured to pass signals in a first IF frequency band and to reject signals in a second IF frequency band; and
routing, during the third mode, the sixth IF signal to the IF port via a second frequency filter configured to reject signals in the first IF frequency band and to pass signals in the second IF frequency band.

7. The method of claim 1, wherein converting, using the first mixer of the first receiver subcircuit of the apparatus, at least the first subset of the first RF signals to the first IF signal comprises:
converting voltage signals corresponding to the at least the first subset of the first RF signals into current signals;
combining the current signals into a combined signal; and
mixing, by the first mixer, the combined signal with a reference signal.

8. A radio frequency (RF) signal processing circuit comprising:
an intermediate frequency (IF) port; and
a first receiver subcircuit communicatively coupled to the IF port and configured to receive first RF signals, of a first RF frequency band, from first antenna elements, the first receiver subcircuit including a first mixer;
a second receiver subcircuit communicatively coupled to the IF port and configured to receive second RF signals, of a second RF frequency band that is different from the first RF frequency band, from second antenna elements;
a controller, communicatively coupled to the first receiver subcircuit, configured to:
cause, during a first mode of the RF signal processing circuit, the first mixer to convert at least a first subset of the first RF signals to a first IF signal; and
cause, during a second mode of the RF signal processing circuit that is a MIMO (Multiple Input Multiple Output) mode, one of (1) the first mixer to convert a second subset of the first RF signals to a second IF signal and the first receiver subcircuit to provide a third subset of the first RF signals to the second receiver subcircuit, and (2) the first mixer to convert at least a fourth subset of the second RF signals to a third IF signal.

9. The RF signal processing circuit of claim 8, wherein the controller is configured to cause, during the second mode, the first mixer to convert the at least the fourth subset of the second RF signals to the third IF signal, the RF signal processing circuit further comprising an RF amplifying and coupling circuit coupled to the first receiver subcircuit and the second receiver subcircuit, and wherein the controller is configured to cause, during the second mode, the second receiver subcircuit to amplify and provide the third subset of the second RF signals to the first mixer via the RF amplifying and coupling circuit.

10. The RF signal processing circuit of claim 9, wherein the first receiver subcircuit comprises a first oscillator circuit communicatively coupled to the first mixer and configured to selectively provide a first oscillator signal, of a first frequency, and a second oscillator signal, of a second frequency that is different from the first frequency, to the first mixer, wherein the controller is configured to cause the first oscillator circuit to provide the first oscillator signal to the first mixer during the first mode and to cause the first oscillator circuit to provide the second oscillator signal to the first mixer during the second mode.

11. The RF signal processing circuit of claim 8, further comprising intermediate frequency routing circuitry communicatively coupled between the first receiver subcircuit and the IF port, the intermediate frequency routing circuitry including a first path without a frequency filter, a second path with a first frequency filter, and a third path with a second frequency filter, wherein the controller is communicatively coupled to the intermediate frequency routing circuitry and configured to cause, during the first mode, the first IF signal to pass through the first path and to cause, during the second mode, one of the second IF signal to pass through the second path and the third IF signal to pass through the third path.

12. The RF signal processing circuit of claim 11, wherein:
the controller is configured to cause, during the second mode, the first mixer to convert the second subset of the first RF signals to the second IF signal and the first receiver subcircuit to provide the third subset of the first RF signals to the second receiver subcircuit;
the first receiver subcircuit comprises a first oscillator circuit communicatively coupled to the first mixer and configured to selectively provide a first oscillator signal, of a first frequency, and a second oscillator signal, of a second frequency that is different from the first frequency;
the second receiver subcircuit further comprises a second oscillator circuit communicatively coupled to a second mixer that is configured to convert the third subset of first RF signals to a fourth IF signal;
the controller is configured to cause the first oscillator circuit to provide the first oscillator signal to the first mixer during the first mode and during the second mode such that the first IF signal and the second IF signal are both within a lower-IF frequency band; and
the controller is configured to cause, during the second mode, the second oscillator circuit to provide a third oscillator signal to the second mixer such that the fourth IF signal is in a higher-IF frequency band that is higher than the lower-IF frequency band.

13. The RF signal processing circuit of claim 12, wherein the first frequency filter is a low-pass frequency filter and the second frequency filter is a high-pass frequency filter.

14. The RF signal processing circuit of claim 8, wherein:
the second receiver subcircuit further comprises a second mixer;
the RF signal processing circuit further comprises intermediate frequency routing circuitry communicatively coupled to the first receiver subcircuit and the second receiver subcircuit; and
the controller is configured to:
cause the first mixer to convert at least a fifth subset of the first RF signals to a fifth IF signal during a third mode of the RF signal processing circuit;
cause the second mixer to convert at least a sixth subset of the second RF signals to a sixth IF signal during the third mode;
cause the intermediate frequency routing circuitry, during the third mode, to route the fifth IF signal to the IF port via a first frequency filter configured to pass signals in a first IF frequency band and to reject signals in a second IF frequency band; and
use the intermediate frequency routing circuitry, during the third mode, to route the sixth IF signal to the IF port via a second frequency filter configured to reject signals in the first IF frequency band and to pass signals in the second IF frequency band.

15. The RF signal processing circuit of claim 8, wherein the first receiver subcircuit includes multiplexers communicatively coupled to the first mixer and configured to receive respective ones of the first RF signals as voltage signals and to output current signals, wherein the first mixer is configured to mix the current signals.

16. A radio frequency (RF) signal processing circuit for converting RF signals to intermediate frequency (IF) signals, the RF signal processing circuit comprising:
means for receiving first RF signals of a first RF frequency band;
means for receiving second RF signals of a second RF frequency band that is different from the first RF frequency band;
first-mode means for converting, using a first mixer, at least a first subset of the first RF signals to a first IF signal during a first mode of the RF signal processing circuit; and
second-mode means, during a second mode of the RF signal processing circuit that is a MIMO (Multiple Input Multiple Output) mode, one of (1) converting, using the first mixer, a second subset of the first RF signals to a second IF signal and providing a third subset of the first RF signals to the means for receiving the second RF signals, and (2) converting, using the first mixer, at least a fourth subset of the second RF signals to a third IF signal.

17. The RF signal processing circuit of claim 16, wherein the first-mode means are for, during the second mode, converting the at least the fourth subset of the second RF signals by the first mixer to the third IF signal, the RF signal processing circuit further comprising:
means for providing a first oscillator signal, of a first frequency, to the first mixer during the first mode; and
means for providing a second oscillator signal, of a second frequency that is different from the first frequency, to the first mixer during the second mode.

18. The RF signal processing circuit of claim 16, further comprising:
means for routing, during the first mode, the first IF signal to an IF port of the RF signal processing circuit without frequency filtering the first IF signal; and
means for routing, during the second mode, one of the second IF signal to the IF port via a first frequency filter and the third IF signal to the IF port via a second frequency filter.

19. The RF signal processing circuit of claim 18, wherein the second-mode means are for converting, using the first mixer, the second subset of the first RF signals to the second IF signal and providing the third subset of the first RF signals to the means for receiving the second RF signals, the RF signal processing circuit further comprising:
means for converting the third subset of the first RF signals to a fourth IF signal;
means for providing a first oscillator signal to the first mixer during the first mode and during the second mode such that the first IF signal and the second IF signal are both within a lower-IF frequency band; and
means for providing a third oscillator signal to a second mixer of the means for receiving the second RF signals during the second mode such that the fourth IF signal is in a higher-IF frequency band that is higher than the lower-IF frequency band.

20. The RF signal processing circuit of claim 19, wherein the first frequency filter is a low-pass frequency filter and the second frequency filter is a high-pass frequency filter.
